(19) United States
(12) Patent Application Publication
(10) Pub. No.: US 2025/0344166 A1
(43) Pub. Date: Nov. 6, 2025

(54) AN APPARATUS FOR PROVIDING SYNCHRONIZED INPUT

(71) Applicant: KONINKLIJKE PHILIPS N.V., EINDHOVEN (NL)

(72) Inventors: Oscar Garcia Morchon, Eindhoven (NL); Ludovicus Marinus Gerardus Maria Tolhuizen, Waalre (NL)

(21) Appl. No.: 18/864,915

(22) PCT Filed: May 11, 2023
(86) PCT No.: PCT/EP2023/062534

§ 371 Date: Nov. 12, 2024

(30) Foreign Application Priority Data
May 13, 2022 (EP) 22173378.5
Jun. 24, 2022 (EP) 22180909.8
Aug. 7, 2022 (EP) 22189161.7
Aug. 8, 2022 (EP) 22189307.6
Dec. 22, 2022 (EP) 22215726.5

(51) Int. Cl. H04W 56/00; H04L 67/131; H04W 28/02; H04W 28/10

(52) U.S. Cl. CPC H04W 56/001; H04L 67/131; H04W 28/0226; H04W 28/0236; H04W 28/10

(57) ABSTRACT

This invention relates to an apparatus for providing synchronized input to a third device, the apparatus comprising a. a memory to store communication parameters shared between the third device and a first device, and/or between the third device and a second device, b. a communication unit to receive a first communication flow from the first device, and/or, a second communication flow from the second device, wherein the communication flows are synchronized based on the communication parameters.

### FIELD OF THE INVENTION

This invention relates to a communication system which requires low latency communication between remote users. This invention may be suitable for (but not limited to) the next generation of real time communication systems or metaverse implementations that can be defined as a virtual-reality space in which users can interact with a computer-generated environment and other users.

### BACKGROUND OF THE INVENTION

Within the 3GPP Technical Specification Group Service and System Aspects (TSG SA), the main objective of 3GPP TSG SA WG1 (SA1) is to consider and study new and enhanced services, features, and capabilities of the 5G system and identify any corresponding stage 1 requirements to be met by 3GPP specifications. These service requirements are documented in normative specifications under SA1 responsibility. A related study is TR 22.847, “Study on supporting tactile and multi-modality communication services (TAMMCS)”. This study includes eight use cases and related requirements for the so-called “tactile internet” (TI).

The International Telecommunication Union (ITU) defines the TI as an internet network that combines ultra-low latency with extremely high availability, reliability and security. The mobile internet allowed exchange of data and multimedia content on the move. The next step is the internet of things (IoT) which enables interconnection of smart devices. The TI is the next evolution that will enable the control of the IoT in real time. It will add a new dimension to human-to-machine interaction by enabling tactile and haptic sensations, and at the same time revolutionise the interaction of machines. TI will enable humans and machines to interact with their environment, in real time, while on the move and within a certain spatial communication range.

IEEE publication P1918.1, “Tactile Internet: Application Scenarios, Definitions and Terminology, Architecture, Functions, and Technical Assumptions” demands that cellular 5G communication systems shall support a mechanism to assist synchronisation between multiple streams (e.g., haptic, audio and video) of a multi-modal communication session to avoid negative impact on the user experience. Moreover, 5G systems shall be able to support interaction with applications on user equipment (UE) or data flows grouping information within one tactile and multi-modal communication service and to support a means to apply 3rd party provided policies for flows associated with an application. The policy may contain a set of UEs and data flows, an expected quality of service (QOS) handling and associated triggering events, and other coordination information.

FIG. 3 depicts a scenario addressed by this invention. Two persons A and B are willing to interact in the metaverse or real time communication application. To this end, person A and B have corresponding rendering devices, e.g., a VR device and corresponding sensor devices. Person A and B are separated by a distance d.

This scenario presents two main issues:

First, if a metaverse application requires a maximum of 1 ms delay, then the maximum distance between person A and person B is of d=300 km since information propagates at 300.000 km/s Second, since a high-quality data representation is required, sensor devices need to sample a high-quality representation of a person that is to be transmitted to the rendering device of the other person. This leads to high data rate requirements.

Furthermore, more than two persons might be involved in the metaverse, where the different persons might be at different locations. For instance, assume Users U0, U1 and U2 interacting with each other at different locations L0, L1, and L2. User U0 receives data from users U1 and U2. When data arrives at U0, it is a requirement that the streams of data of generated by U1 and U2 as well as streams of data of UEs local to U0 are synchronized.

Thus, a third problem is how to synchronize streams of data originated from UEs at different locations.

### SUMMARY OF THE INVENTION

An aim of the invention is to alleviate the above-described problems.

Another aim of the invention is to enable metaverse interactions between people located far away and reducing the communication overhead.

In accordance with a general definition of the invention, a first person interacts with a second person in the metaverse through a predictive model of the second person located close to the first person. The predictive model predicts state at time t based on sensor input sampled at time t(0)=t−d*c, t(1)=t−d*c−T, . . . , t(N−1)=t−d*c−(N−1)*T) where c is the speed of light,

This approach may allow for one or more of the following: First, low latency: instead of direct interaction, person A (B) interacts with predictive model of person B (A). The model of person B (A) predicts the actions of person B (A) based on the input collected by the sensor device B. The predictive model of person B (A) is used in rendering device A (B).

The model of a person may be built when the person joins the metaverse and may be deployed to a suitable location when the person wants to interact with another person'. This suitable location has to be close to the person'.

Second, data compression: achieved by: a) downloading a complex model of a person during initialization at suitable locations; b) limiting the sensor data that needs to be sampled for a suitable predictive model that leads to a realistic representation of the person; . . .

Another general definition of this invention proposes the synchronization of the (predicted) communication flows from different user equipment at different locations by, e.g.:
First, determining the communication parameters (e.g., latency) between users;
Second, synchronizing the flows based on the communication parameters;
Third, applying this synchronization to the usage of the predictive model.

In accordance with a first aspect of the invention, it is proposed an apparatus for providing synchronized input to a third device, the apparatus comprising
a. a memory to store communication parameters shared between the third device and a first device and between the third device and a second device,
b. a communication unit to receive a first communication flow from the first device and a second communication flow from the second device,
wherein the first and second communication flows are synchronized based on the communication parameters.

In accordance with a second aspect of the invention, it is proposed a system comprising at least one communication device of the first aspect of the invention and at least one remote second device for transmitting the received communication flow.

In accordance with a third aspect of the invention, it is proposed an apparatus for providing a derived prediction model of a first device to a third device, the apparatus comprising
a. a storage unit storing a general prediction model of the first device,
b. a communication unit for receiving a communication parameter characteristic of the communication link between the first and the third devices,
c. a computing unit capable of determining a derived prediction model of the first device,
wherein the derived prediction model is obtained based on the general prediction model and the received communication parameter.

In accordance with another general definition of the invention, it is proposed an apparatus for providing synchronized input to a third device, the apparatus comprising
a. a memory to store communication parameters shared between the third device and a first device and/or, between the third device and a second device,
b. a communication unit to receive a first communication flow from the first device and/or, a second communication flow from the second device,
wherein the communication flows are synchronized based on the communication parameters.

In a first variant of this general definition of the invention, the communication parameters include
the distance between the third and first device and/or the distance between the third and second device or
the latency from the first to the third device and/or the latency from the second to the third device or
other communication parameters shared between the first and the third devices and/or between the second and the third devices.

In a second variant, the apparatus further comprises a computational unit executing a predictive model that takes as input the communication parameters between the first and third devices to predict a control input for the third device wherein the control input includes a predicted communication parameter between the first and third devices.

In a third variant, the apparatus comprises a computational unit executing a predictive model that takes as input the communication flow of at least the first device to predict a control input for the third device.

In a fourth variant, the predictive model is at least one of
a model derived from a generic predictive model according to the parameters shared at least between the first and third devices,
a generative model.

In a fifth variant, the communication parameters are obtained by running a protocol with the first device.

In a sixth variant, the communication parameters are configured by a managing device.

In a seventh variant, the communication parameters may be at least one of:
Latency between the third and the first and/or second device,
QoS,
Distance between the third and the first and/or second device,
Computational requirement to process the communication,
Computational capabilities to process the communication,
Memory requirements to process the communication,
Memory capabilities to process the communication,
Available bitrate,
Number of communicating parties,
(relative) position relative to the third and the first and/or second device,
(relative) speed relative to the third and the first and/or second device,
(relative) acceleration relative to the third and the first and/or second device,
(relative) rotation relative to the third and the first and/or second device.

Under this other general definition, the invention is also directed to a system comprising at least one third device comprising an apparatus as defined in the previous definition and its variants and at least one remote first device for transmitting the received communication flow at the third device.

Still under this other general definition, it is also proposed a method for providing synchronized input to a third device, the method
a. storing communication parameters shared between the third device and a first device, and/or, between the third device and a second device in memory,
b. receiving a first communication flow from the first device, and/or, a second communication flow from the second device by means of a communication unit,
c. synchronizing the communication flows based on the communication parameters.

Still under this other general definition, it is also proposed an apparatus for using a prediction model of a first device, the apparatus comprising
a. a storage unit storing a prediction model of the first device,
b. a communication unit for obtaining a communication parameter characteristic of the communication link between the first and the third devices,
c. a computing unit capable of using the prediction model of the first device,
wherein an output of the prediction model is obtained based on the prediction model and the communication parameter.

In accordance with a first variant, the output of the prediction model allows for a synchronized communication flow between the first and third devices.

In accordance with a second variant, the output of the prediction model is a derived prediction model, and wherein the required number of input parameters in the derived prediction model is less than the required number of input parameters of the prediction model.

Still under this other general definition, it is also proposed a method for using a prediction model of a first device, the method adapted to
a. store a prediction model of the first device,
b. obtain a communication parameter characteristic of the communication link between the first and the third devices,
c. using the prediction model of the first device, wherein an output of the prediction model is obtained based on the prediction model and the communication parameter.

It shall be understood that a preferred embodiment of the invention can also be any combination of the dependent claims or above embodiments with the respective independent claim.

It shall be understood that some or all the aspects introduced earlier may be implemented by means of a computer program including instructions which once executed on a computer enable the implementation of the methods covered by this invention.

These and other aspects of the invention will be apparent from and elucidated with reference to the embodiments described hereinafter.

### BRIEF DESCRIPTION OF THE FIGURES

FIGS. 1A and 1B schematically show block diagrams of alternative network architectures for a metaverse implementation in a cellular network;

FIG. 2 schematically shows a state diagram representing the operation of an exemplary system implementing a metaverse application;

FIG. 3 schematically shows an exemplary metaverse implementation;

FIG. 4 represents a Metaverse system in accordance with an embodiment of the invention;

FIG. 5 represents a Metaverse system implemented within a network;

FIG. 6 represents schematically a system in accordance with a further embodiment of the invention;

FIG. 7 represents schematically a system in accordance with a further embodiment of the invention;

FIG. 8 represents schematically a variant of an embodiment of the invention;

FIG. 9A-D represent schematically a system in accordance with a further embodiment of the invention;

FIG. 10 represents schematically a system in accordance with a further embodiment of the invention;

FIG. 11 represents schematically a system in which the previous embodiments may be implemented; and

FIG. 12 represents an exemplary use case for the application of the embodiments.

### DETAILED DESCRIPTION OF THE INVENTION

Embodiments of the present invention are now described based on a cellular communication network environment, such as 5G. However, the present invention may also be used in connection with other wireless technologies in which TI or metaverse applications are provided or can be introduced. The present invention may also be applicable to other applications such as video streaming services, video broadcasting services, or data storage.

Throughout the present disclosure, the abbreviation “gNB” (5G terminology) or “BS” (base station) is intended to mean a wireless access device such as a cellular base station or a WiFi access point or a ultrawide band (UWB) personal area network (PAN) coordinator. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” may be used as synonyms in this disclosure. This means for example that when it is written that the “network” performs a certain operation it may be performed by a CN function of a wireless communication network, or by one or more base stations that are part of such a wireless communication network, and vice versa. It can also mean that part of the functionality is performed by a CN function of the wireless communication network and part of the functionality by the base station.

Moreover, the term “metaverse” is understood as referring to a persistent shared set of interactable spaces, within which users may interact with one another alongside mutually perceived virtual features (i.e., augmented reality (AR)) or where those spaces are entirely composed of virtual features (i.e., virtual reality (VR)). VR and AR may generally be referred to as “mixed reality” (MR).

Additionally, the term “data” is understood as referring to a representation according to a known or agreed format of information to be stored, transferred or otherwise processed. The information may particularly comprise one or more channels of audio, video, image, haptic, motion or other form of multimedia information that may be synchronized. Such multimedia information may be derived from sensors (e.g., microphones, cameras, motion detectors, etc.) or may be partially or wholly synthesized (e.g., live actor in front of a synthetic background).

The term “data object” is understood as referring to one or more sets of data according to the above definition optionally accompanied by one or more data descriptors that provide extra semantic information about the data that influences how it should be processed at the transmitter and at the receiver. Data descriptors may be used to describe, for example, how the data is classified by a transmitter and how it should be rendered by a receiver. By way of example, data representing an image or a video sequence may be broken down into a set of data objects that collectively describe the full image or video and which may be individually processed (e.g., compressed) substantially independently of other data objects and in a manner optimal for the object and its semantic context.

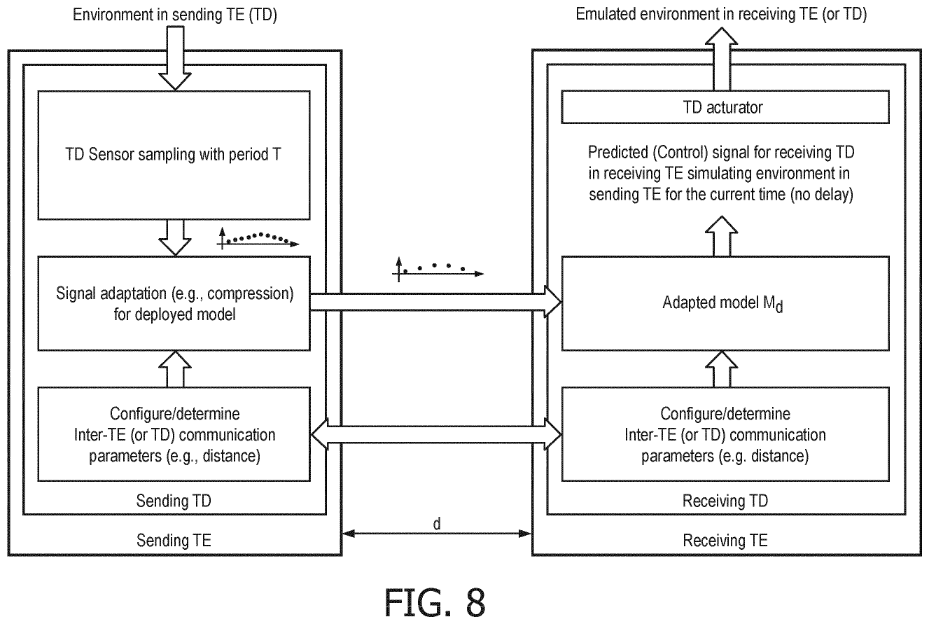

Further, the term “data object classification” is understood as referring to a process in which data is divided or segmented into multiple data objects. For instance, an image might be divided into multiple parts, e.g., a forest in the background and a person in the foreground (e.g., as exemplified later in connection with FIG. 8). Data object classification criteria are used to classify a data object. In this disclosure, such criteria may include at least one of a measure of semantic content of a data object, a context of the data object, a class of compression technique best suited to retain sufficient semantic content for a given context and so on.

In addition, a “compression technique” is understood as referring to a method of reducing the size of data so that its transmission or storage is more efficient. For instance, a method of removing redundant data or data that is considered semantically imperceptible to the end user and efficiently encoding the remaining data such that it is possible to reconstruct a faithful or semantically near-faithful representation of the original data.

Furthermore, a “compression or reconstruction model” is understood as referring to a repository of tools and data objects that can be used to assist data compression and reconstruction. For example, the model may comprise algorithms used in the analysis and compression of data objects or may comprise data objects that can be used as the basis of a generative compression technique. Advantageously, the model may be shared or possessed by a transmitter and a receiver and/or may be updated or optimized according to a semantic content of the data being transferred.

It is noted that throughout the present disclosure only those blocks, components and/or devices that are relevant for the proposed data distribution function are shown in the accompanying drawings. Other blocks have been omitted for reasons of brevity. Furthermore, blocks designated by same reference numbers are intended to have the same or at least a similar function, so that their function is not described again later.

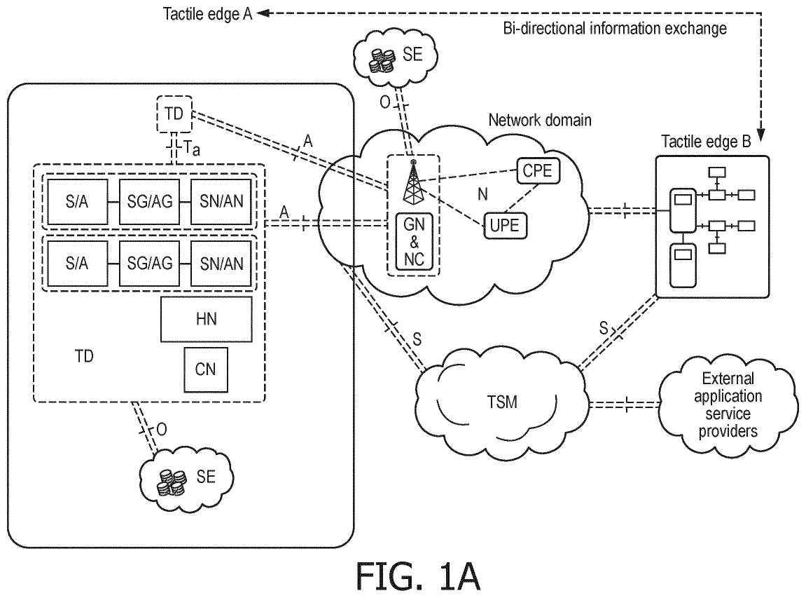

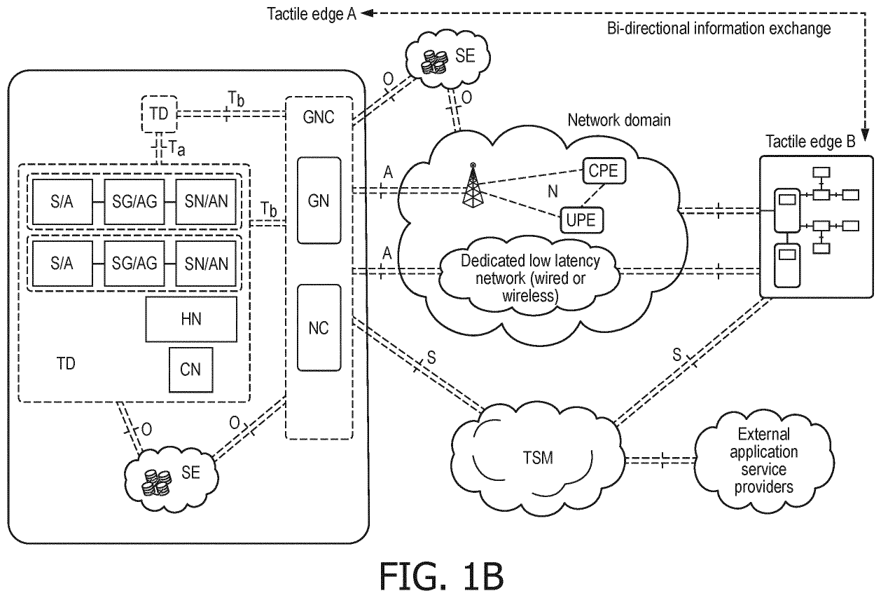

FIGS. 1A and 1B schematically show network architectures considered for implementing a metaverse (e.g., IEEE P1918.1 architecture). The architectures comprise an actuator gateway (AG), an actuator node (AN), a controller node (CN), a control plane entity (CPE), a gateway node (GN, wherein GNC corresponds to GN & CN), a human-system interface node (HN), a network controller (NC), a sensor/actuator (S/A), a computing and storage entity (SE), a sensor gateway (SG), a sensor node (SN), a tactile device (TD), a tactile edge (TE), a tactile service manager (TSM), a user plane entity (UPE), an access interface (A), a first tactile interface Ta (TD-to-TD communication), a second tactile interface Tb (TD-to-GNC communications), an open interface (O), a service interface(S), a network side (N), a network domain (ND), a bidirectional information exchange (BIE), an external application service provider (EASP), and a dedicated low latency network (LLNW).

The architectures of FIGS. 1A and 1B provide an overall communication architecture defined in a generic manner capable of running over/on any network, including 5G. They cover various modes of interconnectivity network domains between two TEs (TE A, TE B). Each TE consists of one or multiple TDs, where TDs in TE A communicate information, e.g., tactile/haptic—with TDs in TE B through the ND, to meet the requirements of a given TI use case. The ND can be either a shared wireless network (e.g., 5G radio access and core network), shared wired network (e.g., Internet core network), dedicated wireless network (e.g., point-to-point microwave or millimeter wave link), or dedicated wired network (e.g., point-to-point leased line or fiber optic link). Each TD can support one or multiple of the functions of sensing, actuation, haptic feedback, or control via one or multiple corresponding entities. The S or A entity refers to a device that performs sensing or actuation functions, respectively, without networking module. The SN or AN refers to a device that performs sensing or actuation functions, respectively, with an air interface network connectivity module. In order to connect S to SN or A to AN, the SG or AG entity should be used, respectively. These gateways provide a generic interface to connect to third-party sensing and actuation devices and another interface to connect to SNs and ANs. A TD can also serve as the HN, which can convert human input into haptic output, or as the CN, which runs control algorithms for handling the operation of a system of SNs and ANs, with the necessary network connectivity module.

The GN is an entity with enhanced networking capabilities that reside at the interface between the TE and the ND and is mainly responsible for user plane data forwarding. The GN is accompanied by the NC that is responsible for control plane processing including intelligence for admission and congestion control, service provisioning, resource management and optimization, and connection management in order to achieve the required QoS for the TI session. The GN and CN (together labelled as GNC) can reside either in the TE side (as shown in FIG. 1A) or in the ND side (as shown in FIG. 1B), depending on the network design and configuration. The GNC is a central node as it facilitates interoperability with the various possible network domain options, which is essential for compatibility with other emerging standards such as the 3GPP 5G NR specifications. Allowing the GNC to reside in the ND, for example under 5G, intends to support the option of absorbing its functionality into management and orchestration functionalities already therein. In FIGS. 1A and 1B, the ND is shown to be composed of a radio access point or base station connected logically to CPEs and UPEs in the network core.

A user in a region of interest (ROI) is surrounded by a set of TDs linked to a TE. A TD might comprise rendering actuators and/or sensors. Rendering actuators have the task of creating a metaverse environment around the user and might be VR glasses, a 3D television (TV), a holographic device, etc. A sensor TD is a device in charge of capturing the actions and/or environment of the user and might include video cameras, audio devices such as microphone, haptic sensors, etc. In general, a TD might be a UE in terms of a 5G system.

The TDs in a ROI may be connected to the TE of the user, e.g., by means of wires or wirelessly. In the wireless case, the UEs may be connected to a base station such as a 5G gNB or to a WiFi access point. The networking infrastructure and computational resources of the TE are either co-located in the ROI or located (distance less than a maximum edge distance) in a close edge server to ensure a fast response.

To assist the implementation of the following embodiments, at least one of three communication functionalities may be introduced. First, latency-based flow synchronization (LBFS) may be provided, which is a functionality that may run in a device in the TE. It could also be deployed in a receiving TD capable of determining communication parameters with sending TDs (or TS) and synchronizing communication flows based on those communication parameters, in particular, the relative latency between TDs (or TEs). Second, an edge application at a TE may be configured to run a latency-dependent configurable predictive model (LDCPM) of the environment/persons in the metaverse session in a different TE. Third, a model management and configuration functionality may be provided, that is capable of registering a generic model of an ROI and/or device and/or person in a TE, storing it in a data base, and deploying a re-configured LDCPM upon determining the communication parameters.

Another pioneering node in the architectures of FIGS. 1A and 1B is the SE that provides both computing and storage resources for improving the performance of the TEs and meeting the delay and reliability requirements of the E2E communications. The SE will run advanced algorithms, employing AI techniques, among others, to offload processing operations that are too resource and/or energy intensive to be done in the TD (e.g., haptic rendering, motion trajectory prediction, and sensory compensation). The goal is to enable the perception of real-time connectivity using predictive analytics while overcoming the challenges and uncertainties along the path between the source and destination TDs, dynamically estimate network load and rate variations over time to optimize resource utilization, and to allow sharing of learned experiences about the environment among different TDs. On the other hand, the SE will also provide intelligent caching capabilities which can be very impactful in reducing the E2E traffic load and thus reducing the data transmission delays. The SE can reside locally within the TE to enhance the response rate for requests from TDs or GNC, and/or it can reside remotely in the cloud while providing services to the TEs and the ND. Moreover, the SE can be either centralized or distributed. Each of these options has its own pros and cons in terms of delay, reliability, capabilities, cost, and practical feasibility. The communications between the two TEs can be unidirectional or bidirectional, can be based on client-server or peer-to-peer models and can belong to any of the above-mentioned use cases with their corresponding reliability and delay requirements. To this end, the TSM plays a critical role in defining the characteristics and requirements of the service between the two TEs and in disseminating this information to key nodes in the TE and the ND. The TSM will also support functions such as registration and authentication and will provide an interface to EASPs of the TI.

The A interface provides connectivity between the TE and the ND. It is the main reference point for the user plane and the control plane information exchange between the ND and the TE. Depending on the architecture design, the A interface can be either between the TD and the ND or between the GNC and the ND. Furthermore, the T interface provides connectivity between entities within the TE. It is the main reference point for the user plane and the control plane information exchange between the entities of the TE. The T interface is divided into two subinterfaces Ta and Tb to support different modes of TD connectivity, whereby the Ta interface is used for TD-to-TD communications and the Tb interface is used for TD-to-GNC communications when the GNC resides in the TE. Additionally, the O interface provides connectivity between any architectural entity and the SE, and the S interface provides connectivity between the TSM and the GNC. The S interface carries control plane information only. Finally, the N interface refers to any interface providing internal connectivity between ND entities. This is normally covered as part of the network domain standards and can include sub-interfaces for both user plane and control plane entities.

Two broad categories of haptic information may be implemented, namely, tactile or kinesthetic, which may be combined. Tactile information refers to the perception of information by various mechanoreceptors of the human skin, such as surface texture, friction, and temperature. Kinesthetic information refers to the information perceived by the skeleton, muscles, and tendons of the human body, such as force, torque, position, and velocity.

A first differentiating aspect of TI and related standards compared with 5G ultra reliable low latency communication (URLLC, ITU-R M.2083) relates to the fact that the TI must be developed in a way that can realize its requirements over longer distances than the 150 km (or 100 km in fiber) separation for a round-trip due to a propagation time of 1 ms. Such capability can be achieved through network side support functions built into the TI architecture, as envisioned through the standards work in IEEE 1918.1. These functions could, for example, model the remote environment using artificial intelligence (AI) approaches and could in some cases also partly or totally be present at the TI end device (i.e., the client of the TI/haptic information).

A second differentiating aspect relates to the fact that TI leads to an application with unique characteristics implied by that application and with the expectation that the application can be deployed as an overlay network on top of a network or combination of networks. It is not intended to apply in the context of 5G URLLC as the underlying communication means only.

Moreover, in the above architectures of FIGS. 1A and 1B, data streams, e.g., haptic feedback, must be synchronized as well and users expect that they should “feel” or “experience” visually depicted events as they occur, regardless of whether the event is heard. Thus, synchronization of audio, video, and haptic data becomes very crucial. This might, incidentally, be achieved by receiver buffering, thereby removing entirely the challenge for the communication network in achieving the required latency (e.g., jitter).

To meet stringent end-to-end (E2E) QoS requirements, the architectures should also provide advanced operation and management functionalities such as lightweight signaling protocols, distributed computing and caching with predictive analytics, intelligent adaptation with load and network conditions, and integration with external application service providers (ASPs).

As a result, reliability, latency, and scalability can be considered as key performance indicators (KPIs), where omnipresence (rapid “latching” of TDs to TI infrastructure), ad-hoc (minimal upkeep of TI network domain), and hybrid (scalable yet minimalistic upkeep of a TI rendezvouz device) can be considered three main approaches for bootstrapping a TI service and instantiating the architecture. The TI design is inherently built on the notion of edge-mandated operational settings and core-managed E2E sustenance. That is, the TD at the edge would state its communication and operational parameters (e.g., expected latency and reliability) and communicate that to the TI architecture, which will then engage the required resources to meet such requirements, both in bootstrapping setup and E2E communication.

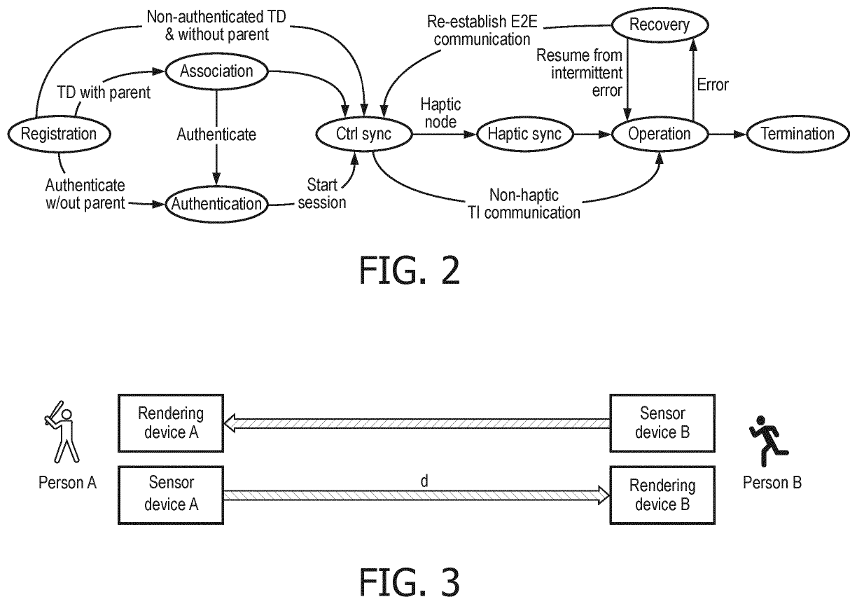

FIG. 2 schematically shows a state diagram representing operational states of an overall operation finite state machine for implementing a metaverse application.

A TD device may start with a registration phase (REG), which is defined as the act of establishing communication with the TI architecture. Under the omnipresent TI paradigm, registration will take place with a GNC, potentially including TI components from the ND, such as the TSM. A selected application can provide a user interface for a user/ROI to register, e.g., in the TSM. The registration may be achieved through the application itself, or through the TSM, and may include registering the TDs that the user/ROI has. It may involve registering a TD as part of the communication infrastructure, e.g., as part of the 5G system (5GS) to have access to functionalities offered by the 5GS such as quality of service (Qos), low latency, edge computing, or synchronization of communication flows.

During registration, the TSM may allocate a TE to the user and/or ROI and/or TDs that is/are close or that is suitable for its communication parameters. In some cases, a sensor TD may generate output that is fed to rendering TDs in the same ROI.

The “latching” point of the TD to initiate registration may be referred to as TI anchor. At this stage, the TD may be probing the TI architecture to invoke E2E communication and may not perform any other functions beyond latching onto the TI architecture. In both the ad hoc and the hybrid models, this step may involve the TSM, potentially via the GNC in the former, to establish registration.

The next state depends on the type of the TD. If it is a lower-end SN/AN, then the TD may have a designated “parent” in its close proximity, with which the TD may need to associate (ASS) first. This parent TI node may thereafter ensure reliable operation and assist in connection establishment and error recovery. If a TD device operates independently, then this would be an optional step. Some mission-critical TDs, as well as new ones, may need to be authenticated (AUT) without parent (Ap) prior to being allowed to join/start a TI session (SS).

Another phase may be an optional state in which a TD (NATD) may communicate with an authenticating agent in the TI infrastructure to carry out authentication. The TSM may be an entity that could carry out this task, perhaps with assistance from the SE when needed, or with significant amounts of traffic. The TD may then commence its E2E control synchronization (Ctrl Sync), where it may probe and establish a link to the end TE. At this state, the TD may not be allowed to communicate operational data, yet may focus on relaying connection setup and maintenance parameters. This may include setting the parameters for interfaces along the E2E path, which may aid the ND in selecting an optimal path throughout the network to deliver the requested connection parameters. This state encompasses the path establishment and route selection phases of TI operation. It may typically involve multiple tiers of the TI architecture, which may communicate to ensure that a path that meets the minimum requirements set in the “setup” message is indeed available and reserved.

If the TD engaging in a TI session is a haptic node (HN) targeting haptic communication, then the next state may encompass the specific communication and establishment of haptic-specific information, still before actual data communication. This state involves deciding on codecs, session parameters, and messaging formats specific to this current TI session. While different use cases may mandate different haptic exchange frequencies, it is expected that every haptic communication will start with a haptic synchronization state (H-Sync) to establish initial parameters. Future changes to codecs and other haptic parameters may then be handled as data communication in the “operation” state (OP). This ensures that all haptic communication will enforce an initial setup, regardless of future updates to the parameters which may be included in operational data payloads.

All TD components may then transition to the operational state. At this state, the E2E path has been established, all connection setup requirements have been met, and the TEs are ready to exchange TI information. During operation in this state, one TD may detect an intermittent network error (ERR), in which case the TD may transition into a “recovery” mode (REC), in which designated protocols may take over error checking and potential correction mechanisms to attempt to re-establish reliable communication. If the error proves to be intermittent and is resolved, then the TD may transition back to the operational state. If for any reason the error perseveres, then the TD may transition back to control synchronization and rediscover whether or not an E2E path is indeed available under the operational requirements set out by the edge user.

Finally, once the TI operation is successfully completed, the TD may transition to “termination” phase (TERM), in which all the resources that were previously dedicated to this TD may be released back to the TI management plane. If that was initially handled by the NC, then the resources return to it. Most typically, the TSM may be involved in the provisioning of TI resources.

FIG. 3 schematically shows an exemplary metaverse scenario where two persons PA and PB are willing to interact in the metaverse. To this end, the two persons have corresponding rendering devices RD A and RD B, e.g., a virtual reality (VR) device and corresponding sensor devices SD A and SD B. The two persons PA and PB are separated by a distance d. Since a high-quality data representation is required, the sensor devices SD A and SD B need to sample a high-quality representation of a person that is to be transmitted to the rendering device of the other person. Therefore, high-quality communication with reduced communication overhead is desired.

In the following, embodiments for enabling high-quality communication or interaction with low communication overhead achieved by compression are presented.

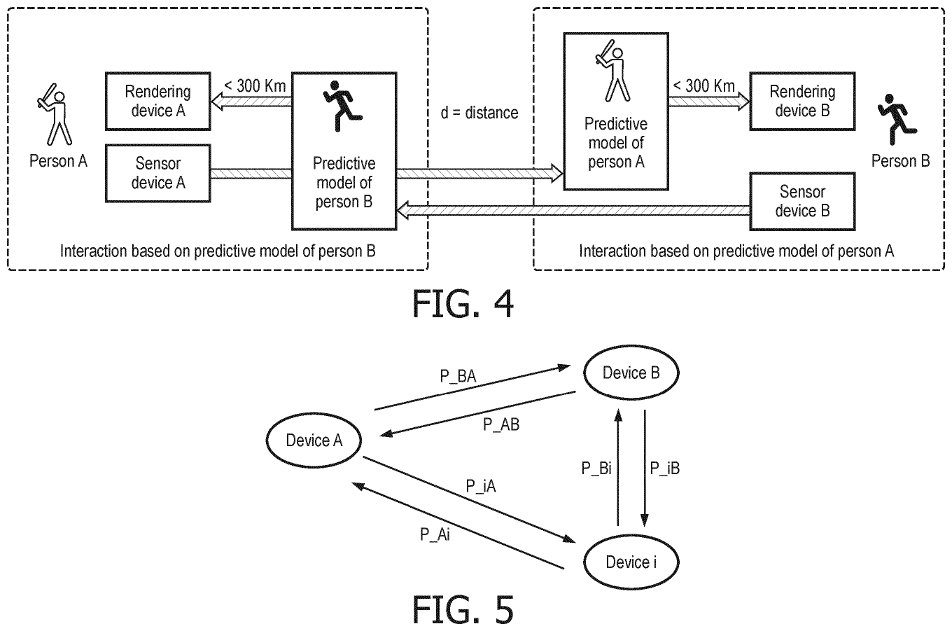

FIG. 4 schematically shows a block diagram of a network architecture for implementing some of the embodiments.

A transmitter (Tx) 22 is understood to be a device that senses or generates data to be compressed (e.g., a 5G UE). Data or compressed data is transferred to a network (NW) 20 via an access link (AL), e.g., a 5G New Radio (NR) radio link. Furthermore, a receiver (Rx) 28 (e.g., a 5G UE) is understood to be a device that renders data or compressed data. Data or compressed data is transferred from the network 20 via an access link (AL), e.g., a 5G NR radio link.

Furthermore, a network (NW) 20 is provided, which is understood to be any type of arrangement or entity that is used to transfer, store, process and/or otherwise handle data or compressed data. The network 20 may comprise multiple logical components distributed over multiple physical devices. In embodiments, network edge servers 24, 29 and a core network (CN) 21 may be provided.

The network edge servers 24, 29 are understood to be devices that are physically close to a radio access network (not shown) and which provide data processing and storage services for a user device (e.g., UE) involved in an interaction or communication. The physical proximity provides for very low latency communications with the user device. In an exemplary application, a transmitting edge server (TxES) 24 and a receiving edge server (RxES) 29 may be provided at the transmitter 22 and the receiver 28, respectively, and may be configured to provide storage capability for data and a compression/decompression database, compression/decompression functions and a negotiation function for negotiating with peer devices.

Furthermore, the core network 21 is understood to comprise remaining parts of the network 20 used to transfer data between the transmitter 22 and the receiver 28, possibly via the respective edge servers 24, 29.

Additionally, a shared storage(S) 23 may be provided as a virtual device that represents memory shared by both the transmitter 22 and the receiver 28 and/or the compression and decompression functions of the edge servers 24, 29. It can be physically located in one or more places with multiple copies being synchronized as necessary.

The communication parameters are understood to be parameters affecting the performance of the communication or posing requirements on the communication. They may include at least one of latency, QoS, distance between communicating parties, computational requirements to process the communication, computational capabilities to process the communication, memory requirements to process the communication, memory capabilities to process the communication, available bitrate, number of communicating parties, and the like. Some of these parameters are related to each other. For instance, the latency between two user devices depends on the distance between the devices, but also on other aspects such as the computational requirements and/or capabilities to process the communication, in particular, if the communication involves a predictive model, the communication latency may be influenced by the available/required computational capabilities of both devices.

In some embodiments, only some of the above communication parameters may be mentioned without loss of generality. For instance, if an embodiment only mentions the latency, this should be understood as latency or other communication parameters, in particular, other communication parameters influencing the latency of a communication link.

In embodiments, sufficient image quality can be provided at the receiving end (e.g., a realistic representation of a person) by using data compression. Such data compression may involve conventional data compression schemes. Additionally, specific data compression schemes and corresponding devices or systems for compressing and decompressing data are described in the following embodiments. It is to be noted that these embodiments, while being beneficial for specific applications mentioned herein, could also be implemented independently, e.g., in other context than metaverse and for other applications.

Embodiments may relate to a first type of system where a compressing device aims at taking some input data and storing it efficiently in a storage unit. This may be useful in a cloud-based setting in which some data needs to be efficiently stored. Here, a compressing device or encoder is used as a device (which may be a software product) that performs data compression. For instance, the device may receive data and may be capable of breaking down (classifying) the data into one or more data objects according to appropriate criteria and then compressing data objects again according to appropriate criteria, storing the compressed data objects together with any necessary compression model and other metadata required to enable later reconstruction of the source data. Appropriate criteria may include consideration of required (semantic) accuracy of reconstruction, available storage space and processing resources for reconstruction and so on. For the purposes of this disclosure, criteria may also include consideration of the semantic content of the data and data objects and compression model(s) to be used.

Optionally, a decompressing device (or decoder) may be provided, which is understood as being a device (which may be a software product) that retrieves compressed data from storage and, using the appropriate (de) compression models, reconstructs and renders the original data with minimal semantic loss. To this end, a compression model repository may be used, which is understood as being a database that comprises tools and data objects to be used for data compression and that, advantageously, is available for both compressing device and decompressing device. A subset of the tools and/or data objects of the repository may be combined to form a compression model that is optimized in some way for a given sample or type of data.

The storage unit is understood as being a device accessible by the compressing device when storing and the decompressing device when retrieving, that stores compressed data and (an) accompanying compression model(s) and metadata. It may also hold the compression model repository. The storage unit may take many forms. It may be a web-based server, for example, or it may be a physical device, such as a memory stick, hard drive or optical disc.

Other embodiments may relate to a second type of system in which a compression/transmitting device aims at exchanging data in an efficient manner with a second decompressing/receiving device. This may be useful in a setting in which a transmitting device (e.g., a streaming service cloud) wants to efficiently share data with a receiving device (e.g., a TV). In some cases, the transmitting device (e.g., the transmitter 22 in FIG. 4) may have sensors capable of sensing/capturing data, e.g., a VR glass or a mobile terminal or user equipment. In some cases, the receiving device (e.g., the receiver 28 of FIG. 4) may have sensors capable of reproducing/rendering data, e.g., a VR glass or a mobile terminal or user equipment. In some cases, an edge server (e.g., edge servers 24, 29 in FIG. 4) may be associated to one of the transmitting/receiving devices taking over and/or sharing some of the functionalities. In some cases, some of the transmitting/receiving devices may be part of a telecommunication system such as the 5G system.

In connection with the other embodiments of the second type of system, a compression transmitting device is understood as being a compressing device that compresses data substantially in a streaming manner, typically taking into account latency or computational overhead or communication overhead at either the transmitting/receiving devices as part of its compression criteria, and which delivers compressed data to a transmission channel. Furthermore, a decompression receiving device is understood as being a decompressing device that decompresses data as it arrives on a transmission channel, typically rendering it in real-time and typically taking into account latency or computational overhead or communication overhead as part of its rendering criteria.

An (optional) edge server may be provided next to the compression transmitting device and may be capable of assisting the compression transmitting device by compression (post-) processing, supplying or updating compression models on-the-fly, or otherwise ensuring timely delivery of compressed data. Similarly, an (optional) edge server may be provided next to the decompression receiving device and may be capable of assisting the decompression receiving device by decompression (pre-) processing, supplying or updating compression models on-the-fly or otherwise ensuring timely rendering of decompressed data.

Moreover, (optional) sensors (e.g., audio, video) may be provided at the compression transmitting device and may be configured as a device or an array of devices that captures some aspect of a scene, typically, but not necessarily in real time. Examples include a camera, a microphone, a motion sensor and so on. Some devices may capture stimuli outside human sensory range (e.g., infra-red camera, ultrasonic microphone) and may ‘down-convert’ them to a human-sensible form. Some devices may comprise an array of sensor elements that provide an extended or more detailed impression of the environment (for example, multiple cameras capturing a 360° viewpoint, multiple microphones capturing a stereo or surround-sound sound field). Sensors with different modalities may be used together (e.g., sound and video). In such cases, different data streams need to be synchronized. The compression transmitting device equipped with sensors may be VR/AR glasses or simply a UE.

In addition, an (optional) rendering device (e.g., audio, video) may be provided at the decompression receiving device and may be a device or an array of devices that renders some aspect of a scene, typically in real time. Examples include a video display or projector, headphones, a loudspeaker, a haptic transducer and so on. Some rendering devices may comprise an array of rendering elements that provide an extended or more detailed impression of a captured scene (for example, multiple video monitors, a loudspeaker array for rendering stereo or surround-sound audio). Rendering devices with different modalities may be used together (e.g., sound and video). In these cases, a rendering subsystem must ensure that all stimuli channels are rendered in synchrony.

Furthermore, a (optional) communication manager may be provided in the system of the second type, which may be an entity, either centralized or distributed, that manages communications. A goal of the communication manager may be to optimize the communication in terms of latency, overhead, etc. The communication manager may be an entity in a communication network such as the 5GS or may be an external entity such as an application function.

As a further (optional) element of the system of the second type, a compression model repository may contain information such as data, machine learning (ML) models used to derive data, etc., useful to reconstruct data based on, e.g., prompts.

In the following embodiments (of which at least some may be combined for further improvement of performance) compression and reconstruction of data may be based on prompts for text-to-image models (such as latent diffusion models), which can be learned on-the-fly to represent previously unseen objects without needing to retrain the entire reconstruction model. This technique (“textual inversion”) can be done quickly and iteratively, as described in Rinon Gal et al.: “An Image is Worth One Word: Personalizing Text-to-Image Generation using Textual Inversion” (retrievable at: https://textual-inversion.github.io/).

Furthermore, in embodiments, compression and reconstruction of data may be based on a system in which generative compression, based on textual inversion, is guided by an input image so that the reconstruction remains similar to that image, as described in Zhihong Pan et al.: “EXTREME GENERATIVE IMAGE COMPRESSION BY LEARNING TEXT EMBEDDING FROM DIFFUSION MODELS” (retrievable at: https://arxiv.org/pdf/2211.07793.pdf).

Additionally, in embodiments, image classification may run rapidly on low-capability devices as described in Salma Abdel Magid et al.: “Image Classification on IoT Edge Devices: Profiling and Modeling” (retrievable at: https://arxiv.org/pdf/1902.11119.pdf).

Typically, diffusion models are good at reproducing items which formed part of their training data set, but bad at reproducing those which did not. Since the training datasets may be taken from the public internet and diffusion models are costly to retrain, this leads to a problem with reproducing a-priori unknown inputs.

For example, a diffusion model may be able to recreate an image of a generic person from a prompt such as “a young man”, but could not recreate an image of any one, specific person (except in some edge cases such as celebrities).

This loss in realism between the regenerated output and the original observations is referred to as “semantic loss” and differs from the distortion introduced by traditional codecs in several ways; notably, by being much more dependent on the original objects being observed.

In addition to semantic Loss, spatial and temporal stability can be a problem. In a related technique (Neural Radiance Fields or NERFs), recent work has addressed techniques for improving spatial and temporal stability.

Recent techniques (e.g., as introduced above) have tried to address the problem of semantic loss. The state of the art in this area is represented by textual inversion, i.e., dynamically learning embeddings representing previously unseen objects, without having to re-train the overall diffusion model. Thus, guide images are used to ensure that learned embeddings adequately represent the observed reality (as represented by the guide image).

FIG. 4 describes an idea underlying this invention to enable low latency interactions, e.g., in metaverse applications, between devices or people located far away while reducing the communication overhead.

In accordance with a general definition of the invention, a first person (or device) may interact with a second person (or device), e.g., in a metaverse application, by means of a predictive model of the second person, where said predictive model is located close to the first person. The predictive model may then predict state or sensor input at time t based on sensor input sampled at previous time, e.g., time t(0)=t−d*c, t(1)=t−d*c−T, . . . , t(N−1)=t−d*c−(N−1)*T) where c is the speed of light and T is a given sampling period. Different types of predictive models may be applicable.

This approach allows for:

First, low latency since instead of direct interaction, person A (B) interacts with predictive model of person B (A). The predictive model of person B (A) predicts the actions of person B (A) based on the input collected by the sensor device B. The (output of the) predictive model of person B (A) is used in rendering device of person A (B).

The model of a person A is built when the person joins the metaverse. This model may be deployed to a suitable location when person A wants to interact with another person B. This suitable location is preferred to be close to person B (e.g. run on a local edge server).

Second, data compression may be achieved by: a) downloading a complex model of a person during initialization at suitable locations; b) limiting the sensor data that needs to be sampled for a suitable predictive model that leads to a realistic representation of the person, e.g., as in a generative model.

Another idea underlying this invention relates to the synchronization of the (predicted) communication flows from different user equipment at different location by:

First, determining the (communication) parameters (e.g., latency) between users.

Second, synchronizing the flows based on the (communication) parameters.

Third, optionally, applying this synchronization to the usage of the predictive model(s).

The communication parameters are parameters affecting the performance of the communication or posing requirements on the communication. The communication parameters may include:
Latency,
QOS,
Distance between communicating parties,
Computational requirement to process the communication,
Computational capabilities to process the communication,
Memory requirements to process the communication,
Memory capabilities to process the communication,
Available bitrate,
Number of communicating parties,
. . .

Note that some of these parameters are related to each other. For instance, the latency between two devices depends on the distance between the devices, but also on other aspects such as the computational requirements and/or capabilities to process the communication or the computational capabilities to perform the rendering of the received data. In particular, if the communication involves a predictive model, the communication latency might be influenced by the available/required computational capabilities of both devices.

Note that in some embodiments only some above communication parameters might be mentioned without loss of generality. For instance, if an embodiment only mentions the latency, this should be understood as latency or other communication parameters, in particular, other communication parameters influencing the latency of a communication link.

Note that in some embodiments, next to the communication parameters, also other parameters may be taken into account in the adaptation of the communication functionality such as transmission time, required data rate, ML model, compression ratio. In particular, said parameters that may be related to the (relative) position, speed, or orientation. These parameters are relevant since if objects/people (involved in, e.g., a metaverse session) are moving closer/farther at a higher speed, then a higher communication rate may be required to perform an accurate rendering. Similarly, a more powerful model may be required to perform a better prediction. Similarly, if the relative orientation of people/devices (involved in, e.g., a metaverse session) change, then also a higher communication rate may be required to perform a better rendering or prediction of the data required for the rendering.

### General Description of the System

This invention is described in the context of a system that focuses on enabling applications such as metaverse applications or immersive teleconferencing systems or immersive real-time communications between a number of persons A, B, . . . , i, . . . , N.

Each person is surrounded by devices D connected with each other through communication links, e.g., 5G communication links, as represented in FIG. 5. A communication link from device i (person i) to device j (person j) is featured by a (communication) parameter set P_ji that might include parameters related to the physical distribution of devices, e.g., distance, speed, orientation or actual communication parameters such as the average latency (that depends on the distance), jitter, bandwidth, reliability, QoS requirements, privacy requirements, etc. Note that some of these parameters might be influenced by, e.g., allocating more resources (e.g., reliability) but other parameters (e.g., latency) cannot be modified. This set of communication parameters can be represented as a squared matrix.

$$[ \begin{matrix}P \_ AA & P \_ AB & P \_ Ai \\ P \_ BA & P \_ BB & P \_ Bi \\ P \_ iA & P \_ iB & P \_ ii\end{matrix} ]$$

The overall system uses the following definitions related to IEEE 1918.1 and FIG. 1. A user in a region of interest (ROI) is surrounded by a set of Tactile devices (TDs) linked to a Tactile Edge (TE). A TD might comprise rendering actuators and/or sensors. A TD rendering actuator may have the task of creating a metaverse environment around the user and may be VR glasses, a 3D TV, a holographic device, etc. A sensor TD is a device in charge of capturing the actions and/or environment of the user and might include video cameras, audio devices such as microphone, haptic sensors, etc. The TDs in a ROI might be connected to the TE of the user, e.g., by means of wires or wirelessly. In the wireless case, the UEs are connected to a base station such as a 5G gNB or to a WiFi access point. The networking infrastructure and computational resources of the TE may be co-located in the ROI or located (distance less than dmaxedge) in a close edge server to ensure a fast response.

In general, a TD might be a UE in terms of a 5G system.

To assist the implementation of the embodiments in this invention, communication functionality may be introduced:

First, latency-based flow synchronization (LBFS): is a functionality that may run in a device in the TE, or could also be deployed in a receiving TD, that is capable of determining communication parameters with sending TDs (or TEs) and synchronizing communication flows based on those communication parameters, in particular, the relative latency between TDs (or TEs).

Second, a latency-dependent/communication-parameter dependent configurable predictive model (LDCPM) (e.g. provided by an edge application at a TE) of the environment/persons in the metaverse session in a different TE.

Third, a model management and configuration functionality capable of one or more of the following: (1) registering a generic model of a ROI/device/person in a TE, (2) storing it in a database, and (3) deploying a (re-configured) LDCPM upon determining the communication parameters.

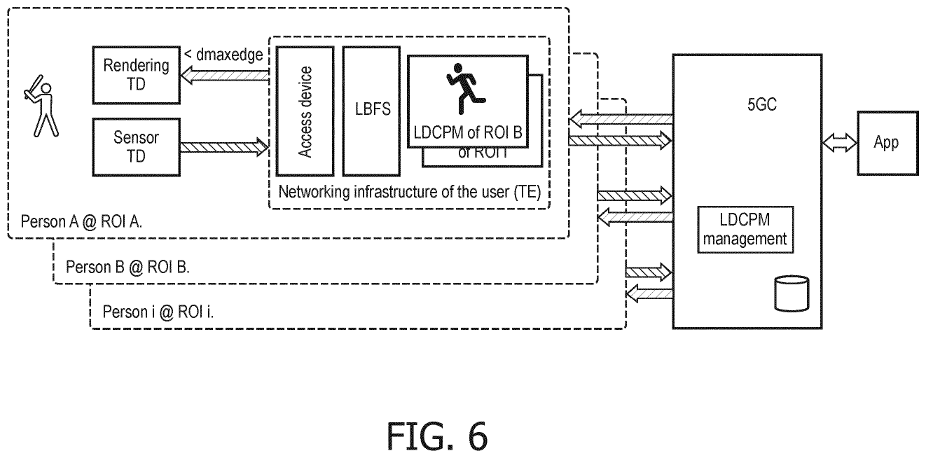

This functionality is shown in FIG. 6 where:

First, the LDCPM management is shown as part of the 5GC system although it could also be an external functionality, either fully or partially. The LDCPM models may be shared by a third-party application and the LDCPM management may store generic LDCPM models in an application and deploy (configured) LDCPM to TDs/TEs when required. For instance, in some embodiments the LDCPM may run on the TE and the LBFS may run on the TE. For instance, in some embodiments, latency-dependent/communication-parameter dependent configurable predictive model may be determined centrally while in other embodiments it may be determined at the entities executing them, e.g., a receiving TE or TD, based on the currently measured communication parameters.

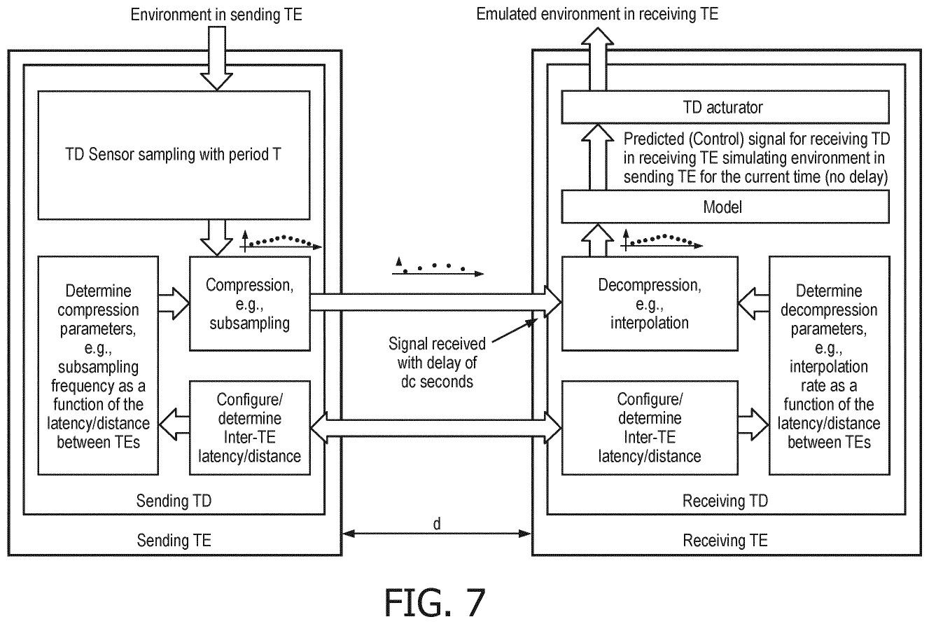

The LBFS or other related building blocks shown in this invention, e.g., the building block in FIG. 7 capable of configuring/determining the inter TE latency/distance/parameters, can be generalized as shown in FIG. 8 as a block capable of configuring/determining inter-TE (or inter TD) (communication) parameters, e.g., orientation of the device and performing actions based on that. For example, synchronizing the communication flows as in some embodiments in this invention.

The sending and receiving TEs might be the same, i.e., the sending and receiving TDs might be in the same TE, and thus, close.

### User Creation, TDs Registration.

The application may provide a user interface for a user/ROI to register, e.g., in the TSM.

Registration may be through the application itself, or through the TSM.

Registration may include registering the TDs that the user/ROI has.

Registration may involve registering a TD as part of the communication infrastructure, e.g., as part of the 5G system (5GS) to have access to the functionalities offered by the 5GS such as Quality of Service, low latency, edge computing, or synchronization of communication flows.

During registration, the TSM may allocate a TE to the user/ROI/TDs that is close or is suitable for its communication parameters.

In some cases, a sensor TD may generate output that is fed to rendering TDs in the same ROI.

The TD registration may also be done during the registration of a UE in the 5GS, e.g., as part of the initial primary authentication. The TD may disclose its capabilities or a NF in the 5GS, e.g., may look up the capabilities of the TD that may be stored in, e.g., the UDM or UDR or other AF. Based on the location of the TD, where the location may be determined by the 5GS/TSM, the TD may be allocated to a given TE. Based on the capabilities of a TD, the 5GS/TSM may allocate computational or communication capabilities to the TD.

### Model Registration, Creation, Deployment, and Use

A model of a user or ROI might refer to one or multiple generic model of a ROI/device/person in a TE, e.g., a model per TD sensor involved, or a model per (person) feature that needs to be rendered, etc.

A model is capable of generating a suitable (predictive) representation of the ROI or person and may rely in different type of artificial intelligence/machine learning models/networks such as generative models.

The user/ROI registration might involve the creation and registration of a (generic) predictive model M of the ROI of the user or the user himself capable of predicting the state of the ROI (or the user). For instance, capable of predicting the state of the ROI/user at time t given N sensed inputs of the ROI/person in the past, e.g., samples generated by a sensor TD at instants of time (t−cd, t−cd−T, t−cd−2T, . . . , t−cd−NT) if the sampling period is equally distributed.

Other sampling distributions may also be feasible, e.g., samples might be denser in the most recent moments of time and less dense in older instants of time:

$$( t - c d , t - c d - 2 T 1 , … , t - c d - NT 1 / 2 , t - c d - NT 1 / 2 - T 2 , \\ t - c d - NT 1 / 2 - 2 T 2 , … , t - c d - N ( T 1 + T 2 ) / 2$$

where T1<T2.

In general, the model might be a function
M (D, cd, T, N)

Where D represents the data sampled at a sensor TD (in a sending TE) and used in the model of the sending user/ROI/TD/TE deployed in the receiving TE, cp refers too the communication parameters (e.g., cd, I.e., the latency L) between the sending TE and the receiving TE, T represents the sampling frequency (or sampling frequencies) of the sensed data, and N represents the number of samples used in the model for inference.

The model may also be based on AI/ML models such as a generative model that allows deriving/generating a given data output (e.g., audio/video/ . . . ) based on (text) prompts. The prompt may be representative of a user and may be used to generate a data representation of the user that may be rendered. The prompt may include metadata indicating the location/orientation of the (to be generated) data representation of the user. This model definition also fits previously mentioned function where D refers in this case to the prompt+metadata information. For instance, the prompt [“Bob”, “Movement_Vector”, “Orientation”, t0] may be a sensor sample and indicate that a generative model should be used to obtain a data representation of Bob who is moving with a given “Movement vector” and has a given “Orientation” at time to. For instance, a given model may make use of N of such data samples.

The model might be created by at least one of:
First, placing sensors (TDs) on the user or around the user,
Second, requiring the user to perform certain movements while
Third, measuring the actual movement, e.g., with additional (calibrated) sensors,
Fourth, measuring the movement with the TDs,
Fifth, using the calibrated measurements to train a model that uses as input the output of the TDs.

The predictive model might refer to a deep learning model such as a recurrent neural network model, such as a long short-term memory (LSTM) model. The predictive model might refer to a single model for the whole TE or to multiple models, e.g., a model per TD in the TE or per user (feature) in the TE.

In some cases, the trained model might be trained to make a prediction “far” in the future, i.e., representing a large latency L=c·dmax, that is linked to the maximum distance dmax between the two TE. For such a model, the TD in the sending TE will send samples of the environment to the TD in the receiving TE. The receiving TE will have been configured with the predictive model of the sending TE and will use N received samples, e.g., the last N received samples, when feeding the model. If the sending and receiving TE are at a distance d<dmax, then the receiving TE will have to delay the stream generated by the model c(dmax−d).

In some cases, the trained model might be trained to make a prediction any time in the future, i.e., representing an arbitrary latency L, e.g., that is linked to the distance d between the two TE or the computational load of those TEs. For such a model, the TD in the sending TE will send samples of the environment to the TD in the receiving TE. The receiving TE will have been configured with the predictive model of the sending TE and will use up to N received samples, e.g., the last N received samples, when feeding the model. In this case, the generated data/stream can be directly used in the receiving TE.

In some cases, the number of samples required in the prediction (input to the model) might be fixed, however, if the latency L (i.e., d) is small, then number of samples exchanged might be lower, e.g., only every second sample sampled at the sending TD might be communicated. The receiving TE might infer the missing samples (e.g., by interpolation) before feeding them into the model. This approach can allow to reduce the communication overhead. FIG. 7 depicts a possible embodiment of this approach.

In FIG. 7, the TD sensor samples with period T the environment in the sending TE. Given a configured (e.g., by the TSM or by the application) or determined (e.g., in a distributed fashion by the sending and receiving TEs) latency (or distance or communication parameter or other parameters of the sampled scene) value between the sending/receiving TEs, the sending TD may determine a compression parameter, e.g., a subsampling frequency for the samples sampled by the sending TD sensor. Compressed samples are then transmitted by the sending TD towards the receiving TD. The samples arrive with a delay of dc seconds. The receiving TD has been configured or has determined the same latency (or distance) between TEs and can use this to decompress the input signals, e.g., determine and apply an interpolation rate for the received signal. Afterwards, the Model takes the N samples corresponding to a time period of N*T seconds to infer a signal capable of controlling an actuator at the receiving TD for the current time, i.e., without delay.

For instance, if the TD sensor returns a prompt of a generative model such that the prompt can be used to regenerate a representation of the remote user, then if the latency is high, the sending TD (TE) may opt to send samples more frequently so that the receiving party can perform a better prediction of the future state of the remote user.

For instance, if the TD sensor returns a prompt of a generative model such that the prompt can be used to regenerate a representation of the remote user, then if the user is moving fast or if the user is changing his orientation fast (e.g., rotating), the sending TD (TE) may opt to send samples more frequently/at a higher data rate so that the receiving party can perform a better prediction of the future state of the remote user and/or a better rendering. In some cases, the number of samples required in the prediction might be variable, e.g., if L (i.e., d) is small, then a smaller number of samples N can be used in the deployed model. This can be achieved if the sending TE has multiple models trained for different (communication) parameters, e.g., different latencies L/distances d, and it selects the most suitable model based on the communication parameters, e.g., distance. This can reduce the CPU needs at the receiving TE. An alternative is that the sending TE trains a generic model that is then converted into an adapted/compressed/tailored model when deployed at a receiving TE featured by certain communication parameters, e.g., a distance d (latency L). In a potential instantiation, the generic model might take as input N samples but a compressed/tailored model may take as input <N samples when d<dmax. This could be achieved, e.g., by combining e.g., the decompression algorithm with the generic model of FIG. 7 into a single block “adapted model” as shown in FIG. 8. This adapted/compressed/tailored model might be created at the sending TE (or sending TD) and deployed directly to each receiving TE (or receiving TD), e.g., once the inter-TE (or TD) communication parameters (e.g., latency/distance) are determined. This compressed/tailored model might be created at a central entity once the inter-TE (or TD) communication parameters (e.g., latency/distance) are determined, and the central entity might trigger the deployment to each receiving TE (or receiving TD).

The sending and receiving TEs might be the same, i.e., the sending and receiving TDs might be in the same TE, and thus, close. The building block shown in FIG. 7 as capable of configuring/determining the inter TE latency/distance can be generalized as shown in FIG. 8 as a block capable of configuring/determining inter-TE (or inter TD or intra-TE) communication parameters, e.g., orientation of the devices.

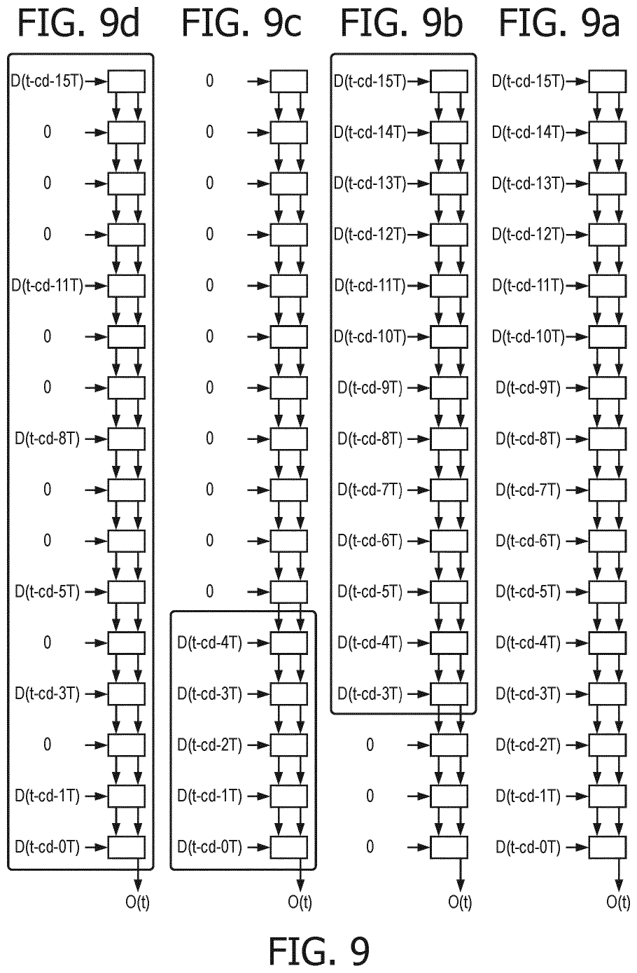

There can be multiple embodiments to obtain such an adapted/compressed model would be, e.g.:
First, combining the interpolation block with the generic model as in FIG. 7, or
Second, using some techniques as in FIG. 9, or
Third, having a model predicting an output T seconds later, and applying it multiple times when the delay is k.

In some cases, the model might have an input N and be designed to make a prediction in a given time cd given N samples as shown in FIG. 9.a. If the sending and receiving TEs are further away that cd, the receiving TE might choose to mask a number of inputs (e.g., k) of the model indicating that they are not available and using a reduced model with N-k input samples and giving a prediction in cd+kN seconds. This is illustrated in FIG. 9.b where k=3. Obviously, in this case the accuracy will drop since some inputs are lost. If the sending and receiving TEs are very close, the receiving TE might choose to mask a number of inputs (e.g., m) of the model indicating that they are not available and using a reduced model with N-m input samples. This is illustrated in FIG. 9.c and FIG. 9.d where m=11 and m=9. The model in FIG. 9.a might be a generic (highly accurate) model that can be reused for multiple receiving TEs at different distances of the sending TE by masking or padding the inputs.

In FIG. 9.a-d, masked inputs are shown to have input value 0, however, other values might be feasible, e.g., the same value as the previous unmasked input, the interpolation of unmasked inputs, etc.

This technique can also be used for data compression, for instance, if the receiving TE is close, the sending TE might decide to only send every second sample from the TD sensor and inform the receiving TE that it has to mask every second input in the model.

This technique can also be used to simplify a generic model into a compressed model when certain inputs are masked since operations can be combined given the fact that some of the inputs are (always) masked.

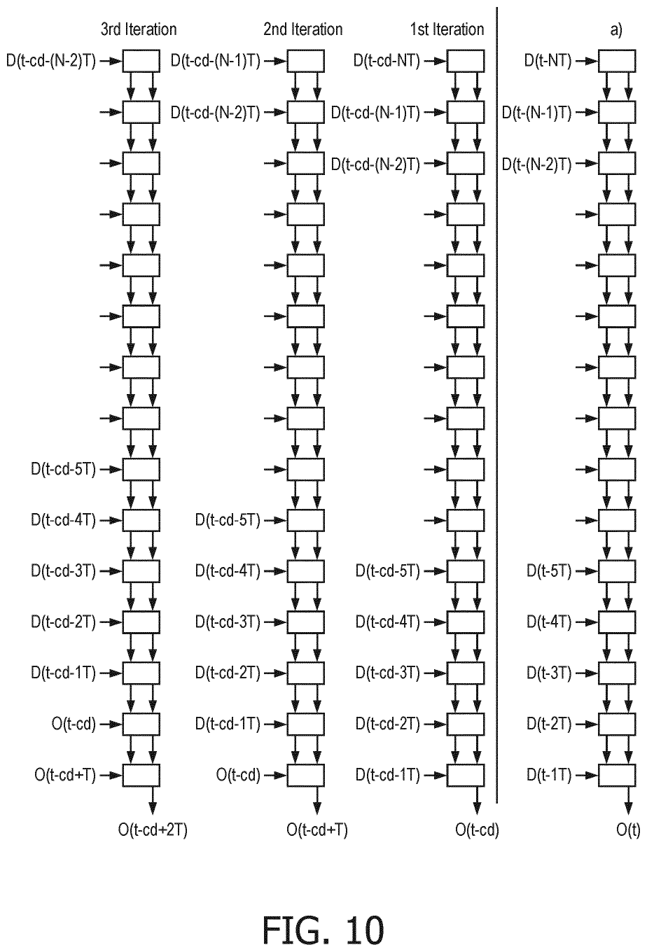

In a different embodiment, the generic model might be e.g., a LSTM network capable of predicting a value for a given fixed delay T, e.g., as it might be represented in FIG. 10.a. In this embodiment:

If a receiving TE (or TD) is at a distance d=T/c from the sending TE (or TD), then a single iteration is required.

If the receiving TE (or TD) is at a distance d=2T/c from the sending TE (or TD), then two iterations of the model are required where the output of the first iteration is used as input in the second iteration.

If the receiving TE (or TD) is at a distance d=3T/c from the sending TE (or TD), then three iterations of the model are required where the output of the first iteration is used as input in the second iteration, and the outputs of the first two iterations are used as input in the third iteration.

In general, if the receiving TE (or TD) is at a distance d=kT/c from the sending TE (or TD), then k iterations of the model are required where the output of the first iteration is used as input in the second iteration, . . . , and the outputs of the first (k−1) iterations are used as input in the last iteration.

Additionally or alternatively, in other predictive models, a prompt may be used to regenerate the content at the receiver side. The prompt might have been extracted at the sender side from the input content. The same content may be generated at the receiver side from the prompt if the predictive model is shared. If the content is an object or a person, and the object or person is moving e.g., at a given speed, then the predictive model at the side of the receiver may predict where the object/person/etc will be located taking into account the speed of the person and the latency of the communication.

For instance, assume that the transmitter observes person Oscar on the left side of an image and Oscar is moving towards the right at a speed of 10 m/s. Assume that the transmitter can extract OscarPrompt from the image. Assume that the image has a width of 3 m and a width in pixels of 1920 pixels. Assume that a receiver receives data from the transmitter with a latency of 30 ms. Assume that the transmitter sends to the receiver ““OscarPrompt”, current location: left_size; current_speed: 10 m/s” then the receiver takes prompt “Oscar” to reproduce the image of Oscar and takes into account the speed information and latency information (from transmitter to receiver) to show/display/render the image of Oscar starting in pixel (10 m/s*0.03 s)*1920 pixel/3 m=192 pixel.

In this example, if the receiver receives data from two transmitters, e.g.: ““OscarPrompt”, current location: left_size; current_speed: 10 m/s”, latency 30 ms ““AlicePrompt”, current location: left_size; current_speed: 10 m/s”, latency 10 ms

The receiver will show the images of both Oscar and Alice on top of each other even if the data arriving from Alice is received 20 ms earlier than the data arriving from Oscar. The reason is that the models account for the delay/latency of the communication when synchronizing the communication flows, e.g., predicting the current locations of the persons/objects/content to be rendered/displayed.

### Communication Infrastructure Configuration

In an embodiment, the metaverse application making use of the communication infrastructure may be capable of configuring the communication infrastructure.

This configuration might be done through the TSM that coordinates the underlying networks.

A 5G (or 6G) TSM might be present in the 5GS (or 6GS).

The TSM would interact with the 5G TSM when both entities are present. This means that the TSM may act as an overarching entity that orchestrates the application communication, e.g, metaverse application while the 5GS TSM has responsibility for the 5GS. This is also relevant in case that multiple 5GS are involved, e.g., a 5GS of a home network and a 5GS of a visiting network. It may also be that the 5G TSM of the home network acts as the overarching entity and the 5GS TSM of the visiting network “reports” to it (5GS of the home network).

This configuration might be done by means of a policy.

This policy might include configuration items for each TD in each TE, e.g., that may be involved in a communication link or session.

The application might add entries to the policy corresponding to the new TD or TE, e.g., every time/when a new TE (TD) joins a (new) (metaverse) communication session, the authorization changes, etc

The TSM might distribute the policy of the new TD (TE) to all existing TDs (TEs) already involved in the (metaverse) communication session.

The TSM might distribute the policy including entries of all existing TDs (TEs) already involved in the (metaverse) communication session to the new TD (TE).

This configuration might be a one-time configuration or might be a Metaverse session configuration for a metaverse session between a number of TEs (e.g., a number of users (A, B, . . . , i, . . . ).

The configuration might include a policy specifying, e.g., at least one of:
First, QoS goals depending, e.g., on number of users, relative latency,
Second, re-synchronization delays applicable to the data flows originated at the sending TE (or at the sending TDs in a sending TE) as well as re-synchronization flows applicable at the receiving TE (or receiving TDs in a receiving TE): TAU_i, TAU_j, TAU_bm, TAU_am as explained in other embodiments.
Third, need of continuous monitoring of the latency between TEs as well as update rate of parameters as explained in other embodiments.
Fourth, latency requirements for each of the TD in a TE, . . . , so that compression or models are correspondingly adapted
Fifth, predictive model of each TD in a TE, . . . , so that the TSM can deploy the model or a compressed model of it to the other TDs/TEs in the communication session.
Sixth, need of QoS equalization, and if applicable, method as in other embodiments.

Similarly, the communication infrastructure might also inform the Metaverse application about communication parameters or other parameters such as the relative positions of the TDs and/or configure the Metaverse application.

Application Start by User at TDi/TE/i, Learning/Configuration of Parameters, e.g. Communication Parameters

In an embodiment, when a user starts a metaverse application involving one or more (remote) users, the communication infrastructure needs to learn the set of parameters, e.g., communication parameters, with the rest of users/ROIs. This can be done in two main ways:

First, end-to-end learning from new TD (or TE) to the other TDs (or TEs): in this case, the new TDs of the TE are configured by the TSM or application with the identities of other already existing TDs/TEs involved in the current communication/metaverse session. The already existing TDs/TEs are also informed about the potentially new TDs/TE. Existing TDs/TEs may also retrieve information about new TDs/TEs, e.g., from a repository. TDs (or TEs) can perform a distributed learning, i.e., TD to TD or TE to TE, of the parameters, e.g., communication parameters, e.g., distance or latency. For instance, two remote TDs might measure the round-trip time and divide it by two to determine the latency (distance) of the communication link. For instance, two remote TDs may share with each other their current speed/orientation so that they can derive, e.g., their relative speeds/orientations.

Second, TSM supported based on the communication of parameters, e.g., latencies from TDs/TEs to the (5G) TSM: in this case, the new TDs of the new TE are registered in the system and the parameters, e.g., latency, from the new TDs/TE is measured from/to the (central) networking infrastructure, e.g., a relevant point through which (all) communication of (all) involved TEs goes through. For instance, a remote TD might measure the round-trip time with the central networking infrastructure and divide it by two to determine the latency (distance) of the communication link; alternatively, the central networking infrastructure might perform this action. Given this measurement, the TSM can compute the end-to-end communication parameters between each pair of TDs/TEs and configures a) the new TDs of the new TE or the new TE with the communication parameters of existing TDs/TEs and b) the existing TDs/TEs with the communication parameters with the new TDs/TE. For instance, the TSM might collect information about the orientation of the TDs, and determine their relative orientations. The TSM may then use this information to adapt the communication parameters.

Other parameters and/or communication parameters might also be learned in a similar way and/or parameters and/or communication parameters might be exposed, e.g., (available) computation capabilities of the TE/TDs might be shared with the TSM.

The TSM might use the learned parameters and/or communication parameters or expose/exchange/share them with an application, e.g., an application function in or outside the 5G system.

### Application Start by User at TDi/TE/i Triggers Deployment of Predictive Model at the Remaining TDs/TEs

In an embodiment, when a user starts a metaverse session, the model of the TE/TDs of the user might be shared by the application with the TSM.

The TSM might then determine which TDs/TEs already associated with the metaverse session require the model.

The TSM can either directly configure the TDs/Tes with the parameters, e.g., communication parameters/latencies/distances, between them or let them determine them in a pairwise manner.

The TSM can then select suitable compression parameters.

The TSM can compute compressed versions of the models to be deployed depending on, e.g.:
First, communication parameters/latency/distance between TDs/TEs: for instance, if the communication parameters between the source TD/TE and the target TD/TE indicate a big distance/latency, then the deployed model might be more complex in terms of the number of past samples that are used in the prediction.
Second, computing capabilities: for instance, if computing capabilities are not enough for a highly accurate model, then a simplified model is deployed requiring fewer computing resources for the prediction.
Third, other parameters, such as relative position/speed/orientation between TDs/TEs.

The user/networking infrastructure may be informed when the model has been successfully deployed in all target TDs/TEs since this can serve as indication that the communication may start

The metaverse application is also informed once this happens so that the user(s) can start the metaverse session.

Alternatively, the TSM might expose said parameters, e.g., communication parameters or a subset of them to the metaverse application/user that would then derive suitable models.

### Operation—Unicast vs Multicast Flows

Unicast communication flows require keeping N M unicast flows per sensing TD (N devices) towards each actuator/rendering TD (M devices). This can become less efficient as N and M increase.

A more efficient approach consists in a multicast approach in which each sensing TD multicasts its flow and the flow is distributed to each of the subscribed rendering TDs. This involves N multicast flows even if it is still important to consider that the multicast flow might reach different rendering TDs/TEs at different instants of times, and those TDs/TEs receiving the multicast flow earlier might use, e.g., a compressed model of the sending TD/TE while those TDs/TEs receiving the multicast flow later might require, e.g., a less compressed model.

Therefore, the multicast flow might include multiple data streams tailored for compressed models with a different compression ratio.

### Operation—Synchronizing of Data Flows

In an embodiment, the sending TE synchronizes outgoing communication flows originated in sensing TDs in the TE. This can involve, e.g., that the TDs or the TE is configured with a policy determining how to synchronize the communication flows originated from multiple sensing TDs in the TE involving sensors with different sampling frequencies such as video, audio, or haptic sensors. Those sensors might not be fully synchronized, or the sampling instant might not be aligned, and thus, the networking infrastructure in the TE might re-synchronize those communication flows among them. To this end,
First, each of the data flows i originating from a TD i in the TE might be delayed a time TAU_i;
Second, the values TAU_i can be configured by means of a policy;
Third, the TE/TDs may be configured with the sampling instant;
Fourth, the TE/TDs may be configured with communication resources that allow a synchronous retrieval of the sampled data;

Furthermore, a TE j might be in charge of aligning all its outgoing flows with the remaining of data flows in the system by delaying all data flows a delay TAU_j.

To achieve this the metaverse application executed at the sensing TDs might need to expose data/parameters, e.g., related to sampling frequency and/or instant (sampling time) and/or clock, etc, of each of the sensing TDs to the underlying communication infrastructure, e.g., the 5GS. This might be exposed through the TDs themselves, through the 3rd party application communication with the TSM, etc.

Once this information is made available, a policy can be deployed to the networking infrastructure (e.g., 5G) that determines how outgoing communication flows are to be synchronized and the delay values TAU_i and TAU_j to be applied at the sending TDs/TE for each of the outgoing communication flows.

In another embodiment, the receiving TDs in a receiving TE are instructed to synchronize incoming flows. Flow synchronization might also be applied in the TE for all receiving TDs.

This can imply that a TD (or TE) might be configured with a policy that requires applying a delay TAU_bm and/or TAU_am to each incoming flow.

The delay TAU_bm might be applied before passing the data to the (compressed) model for the inference of the (control) signal of a given TD.

This delay might allow for fine synchronization of the input from the received input data stream.

The delay TAU_am might be applied to the obtained (control) signal from the model in case, e.g.,
(1) that a generic model is applied at the receiving TE that generates a (control) signal corresponding to a maximum latency/distance or current time while the receiving TE is located at a distance d from the transmitting TE that is less than dmax, and thus, TAU_am=c(dmax−d) or
(2) that the predicted signal is slightly to in the future.

As in the previous embodiment, all communication flows originating in a sending TE might also require applying a delay TAU_j (if this delay is applied in the receiving TE, then TAU_j might not be required in the sending TE).

The input to the model might depend on the communication parameters between the receiving TD (TE) and the sending (remote) TD/TE so that the output of the model (of the remote environment) corresponds to the current state of the remote environment at the sending TE.

All or part of the configuration parameters, e.g., delays, might be configurable in a TD or TE.

All or part of the configuration parameters, e.g., delays, might be stored, e.g., in a database, in the communication infrastructure or in an external metaverse application.

All or part of the configuration parameters, e.g., delays, might be exchanged between the communication infrastructure (e.g., a telecommunications network) and an external metaverse function or exposed to said external metaverse function.

Operation—Flow Synchronization Based on Relative Latencies without Predictive Model

In a related embodiment, incoming flows (originated from multiple TEs) are synchronized based on configuration policy, in particular, based on the communication parameters, in particular, based on the relative distances (or latencies).

In particular, if a TD1 (at TE1) receives two communication flows F21 and F31 from TD2 (at TE2) and TD3 (at TE3) featured by latencies L21 and L31 such that L21<L31, then flow F21 is delayed a time (L31-L21) so that it is synchronized with flow F31.

Operation—Flow Synchronization Based on Relative Latencies with Predictive Model

In a related embodiment, the actions of a user 1 in TE1 would need to be rendered with a delay L31 since the latency within the TE1 can be considered 0. This might be disturbing for the user.

Thus, instead of delaying the communication flows that arrive at a TE earlier, e.g., the communication flow F21, the predictive model linked to TE2 deployed in TE1 is in charge of predicting the timing of state of TE2 at the current time given previous samples received at TE1 as indicated in other embodiments, e.g., the embodiment related model registration, creation, deployment, and use.

### Operation—Continuous Latency Monitoring/Prediction (e.g., for Communications Over Satellite Link)

In some circumstances the latency/distance between users/ROIs is not static, but it is variable due to the underlying networking infrastructure. For instance, a communication link might be based on a satellite link and the distance between satellite links might be variable if the satellites are not located in geostationary orbit. Similarly, communication links might suffer congestion leading to a higher latency. Thus, there is a need to deal with such a latency variable communication links.

In order to address this need, in an embodiment that may be combined with other embodiments, the following methods might (individually or in combination) be required to be (periodically) applied, e.g., with a frequency specified in a policy configured by the TSM:
First, UEs or networking infrastructure or 5GS keep monitoring the communication parameters, e.g., end-to-end latency in a distributed manner and updates the communication policies. For instance, two remote TDs might measure the round-trip time and divide it by two to determine the latency (distance) of the communication link.
Second, the communication infrastructure (e.g. 5GS) keeps monitoring and/or predicting and/or making available to the UEs or networking infrastructure the communication parameters between UEs/networking infrastructure, e.g., the end-to-end latency.
Third, the communication infrastructure (e.g., 5GS) might require the storage of the expected/average communication parameters (e.g., latency, congestion level, jitter level, . . . ) of communication links (e.g., between two routers) in order to estimate the communication parameters of an end-to-end communication link based on the chosen communication path.
Fourth, the communication infrastructure (e.g., 5GS) might expose to an application function (e.g., a Metaverse application function), either located in the communication infrastructure, e.g., 5G CN, or outside of the communication infrastructure, the expected or predicted end-to-end communication parameters. This application function might use the communication parameters to compute a tailored model, that can be shared and deployed in the communication infrastructure.
Fifth, the communication infrastructure (e.g., 5GS) might expose to an entity (e.g., TE) running a predictive model the expected or predicted end-to-end communication parameters (e.g., latency) with/between the communicating remote parties so that the entity can—by using the end-to-end communication parameters:
adapt the base model of the remote communicating party to a tailored model of the remote communication party that can be used to compute a predicted value based on an input stream received from the remote communication party and/or
use the base model of the remote communicating party in combination with an input stream received from the remote communication party to compute a predicted value.
Sixth, the communication infrastructure (e.g., 5GS) might coordinate a base model of a first communicating party where the usage of the base model is (constantly) adapted to the communication parameters between the first communicating party and a second communicating party served by the communication infrastructure, e.g.,
the communicating infrastructure can adapt or keep adapting the base model to be tailored based on the real-time communication parameters between the first and second communicating parties.
the communicating infrastructure can adapt or keep adapting the input to the base model generated from the input data stream received from the second communication party based on the real-time communication parameters between the first and second communicating parties.

Above techniques may also be applied to/used for other parameters, e.g., relative positions/speed/orientation of TDs.

### Operation—Continuous Monitoring of the Relative Positions of Transmitter/Receiver and Adaption of Communication Settings

In some scenarios, if the relative positions of transmitter/receiver UEs such as TDs change fast, then it is natural to require a higher data rate to ensure that the mutual renderings are accurate. This is of particular importance if the UEs are, e.g., integrated in AR/VR glasses because the movement of the user influences the movement of the UE and the point of view of the user. If two remote users wearing AR/VR glasses engage in a remote (metaverse) application, then the required communication flow speed may be kept low if their relative positions are stable, but it may require a higher flow speed if their relative positions change.

Relative positions may refer to: relative speed, relative location, relative acceleration, relative orientation, etc

Thus, in an embodiment, the transmitting and receiving TDs (TEs) share their position (location, speed, acceleration, orientation, etc) with each other. This allows them to determine their relative positions, and therefore, determine whether the required data rate is sufficient.

In a further embodiment, the transmitting and receiving TDs (TEs) share their position (location, speed, acceleration, orientation) with a central management entity. This allows the management entity to determine the relative positions of the transmitting and receiving TDs (TEs), and therefore, determine whether the required data rate is sufficient.

In a further embodiment, the TDs (TEs)/central management entity determines the data rate of a given application, e.g., a metaverse application, based on the relative position of the transmitting and receiving TDs (TEs).

In a further embodiment, the telecommunication system may have an interface to share with an external application the position (location, speed, acceleration, orientation, . . . ) of TDs and/or the relative position of TDs and/or receive a configuration from an external application about the required data rate.

In a further embodiment, the devices (e.g., TD) or a managing entity may run a predictive model to predict the position of other TD and/or predict the relative position with respect to other TD in order to estimate the required data rate.

In a further embodiment, the current or predicted relative positions are used by the transmitting/receiving TDs and/or managing entity to orchestrate/coordinate/trigger/adapt:
Resource allocation in the RAN of the transmitting and/or receiving UEs,
Data rate of the encoded data,
. . .
In a further embodiment, the devices (e.g., TD) or a managing entity may perform one or more of the following tasks:
Task 1: request and/or receive from the RAN or a core network service (e.g. AMF, SMF, LMF, NWDAF) of the transmitting and/or receiving UEs an indication about the communication parameters (e.g., between both UEs or between both RANs) and/or the (relative) position parameter of the UEs, and/or
Task 2: request and/or receive from the RAN or a core network service (e.g. AMF, SMF, LMF, NWDAF) of the transmitting and/or receiving UEs an indication of the available resources in the RAN (e.g., which timeslots are available, which resources are available to offer a given throughput with a given delay, which QoS/QoE is possible and/or can be guaranteed, which CPU capabilities are available) and/or
Task 3: may indicate to the RAN of the transmitting and/or receiving UEs the required resources (e.g., which specific timeslots are preferred to be allocated for the communication link between the UEs, which CPU resources are required, . . . ) and/or
Task 4: May request the remote end device(s) to adapt the transmission quality (e.g., by adapting the data rate) and/or
Task 5: may expose information to an external managing function (e.g., an AF) and/or receive commands from that external managing function related to Tasks 1-4.
Task 6: may perform some of these Tasks in a specific order, e.g., first Task 1, then Task 2, and then Task 3, and/or
Task 7: perform some of these Tasks (e.g., Tasks 3 and/or 4) upon determining a change in the parameters of Task 1, e.g., the communication parameters (higher latency) or relative position (e.g., orientation of the UEs changes).

This can allow that the allocated resources in the RANs of the transmitting and/or receiving UEs are synchronised and sufficient to deliver the required service without incurring, e.g., too high latency.

### Operation—QoS Equalization

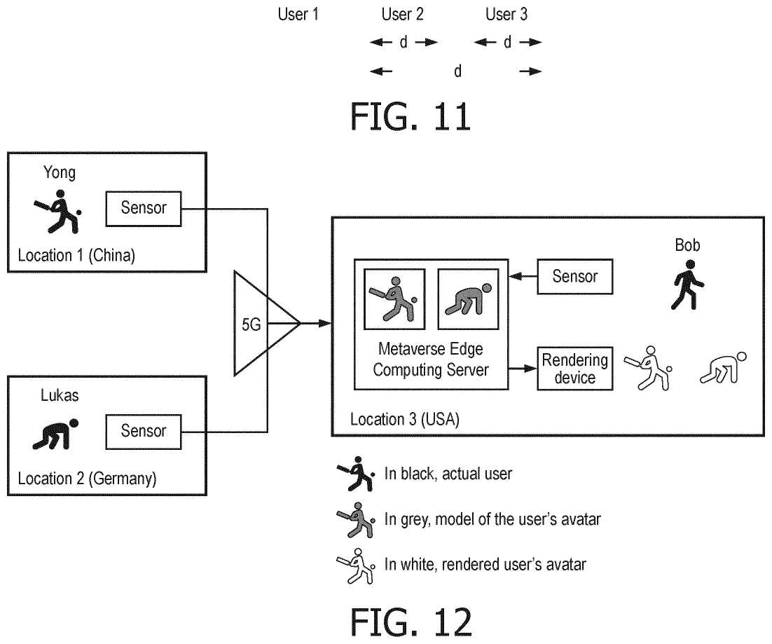

In some metaverse scenarios, a user might have different/better communication parameters with the rest of the users. For instance, as illustrated in FIG. 11, user 2 is located between user 1 and user 3. Thus, user 2 receives communication flows from user 1 (or user 3) twice as fast as (with half of the latency) user 1 (or user 3) receives a communication flow from user 3 (or user 1).

If the techniques described in above embodiments are applied, communication flows originated in TDs and TEs of each corresponding sending user can arrive in a synchronous manner at the receiving TDs/TEs of each user. This can also require the use of a predictive model. However, since user 2 is still closer to user 1 and 3, the quality of the predicted signal might still be better for user 2 than for users 1 and 3. The reason is that user 2 needs to apply the received input to a predicted model requiring a prediction less far in the future; however, e.g., user 1 needs to apply the non-synchronized received input to a prediction model requiring a prediction further in the future.

In such a situation, the metaverse application might instruct the (5G) TSM, and the TSM the underlying networking infrastructure to equalize the provided QoS offered to the users involved in a metaverse communication session. This might involve, e.g.:
First, penalizing a user that might have a communication advantage due to, e.g., his location, by delaying the communication flows originating in such a user (in the example user 2), and/or.
Second, providing a suboptimal model to users (TEs/TDs) in a more favorable situation (in the example user 2), and/or
Third, allocating more computational resources or powerful model to some of the users in a less favourable situation (in the example, users 1 and 3), and/or
Fourth, configuring parameters for the above actions.

Although this might sound paralogical, this might be useful in applications such as gaming since otherwise such a user would always have a given advantage compared with the rest of the users.

To achieve this goal, the metaverse application might instruct the core networking infrastructure to provide QoS equalization. The core networking infrastructure then configures the communication flows, e.g., by deploying a policy at the edge networking infrastructure to force Qos equalization.

Operation with Split Rendering

The above embodiments are also applicable to architectures using split rendering. Split rendering means that the heavy rendering processing is done by a device with high computational resources (e.g., the tactile edge device (TED), e.g., an edge server) and the later stage user-specific or device-specific light rendering is done locally, e.g., at a tactile device (TD). Split rendering allows offloading computations to the TED keeping TDs simple. When a split rendering architecture is used, then the predictive model (e.g., as described in the Embodiment related to model registration) might be executed at the TED.

One or multiple predictive models might be executed per user. One of those predictive models might be, e.g., for a prediction the volumetric video (VV) representation of a user so that a user can be represented in a photorealistic manner. The TED might execute multiple predictive models, e.g., a predictive model per user, and might require the synchronization (e.g., based on the Embodiments related to the Operation-Synchronizing of data flows) of the data streams of the multiple users at different locations/TEs having multiple tactile sensors. If the TED runs the predictive models of the multiple remote users, the TED might render a combined and time synchronized and time-predicted representation, e.g., VV rendered representation, of all the users involved in the metaverse session. Time synchronized means that the generated data streams are aligned, i.e., they follow a common clock. The received time synchronized data streams (from other remote TEs) might arrive a given time Delta later compared to the local clock of the local TE. Thus, time-predicted means that the representation is predicted a time Delta in the future to synchronize it with the local clock of the local TE/TED. This time Delta might depend on the latency or communication parameters between each pair of remote TEs/TEDs.

The TED might consume information about the local users, e.g., the local rendering devices (e.g., TD) associated to the users in the local environment. For instance, the TED might consume the height, position, and orientation of VR/AR glasses that a user is wearing. With this information, the TED can derive a TD specific representation of the environment that can be consumed by a rendering device (TD) of the user. For instance, this representation might be a 2D representation of the volumetric video rendering at the edge server from the perspective of the rendering device (e.g., VR/AR glasses) of the user. For instance, the TED may use the consumed/received data related to the position of the VR/AR glasses to determine the relative position with respect to the VR/AR glasses of another user, and adapt communication parameters accordingly, e.g., required bitrate.

In this environment, a local TED requires the communication system to allocate communication resources so that TDs in the environment can continuously provide input related to, e.g., their pose. This may be done in a time deterministic manner. For instance, the 5GS might allocated H resource blocks every m milliseconds to transmit data related to the head pose. If this is done, the delay when the TED receives the pose of the user is T=Tsensing+m+Tflight where Tsensing is the processing delay from sensing the pose till the value can be sent, m is the delay due to the discrete measurements, and Tflight is the propagation time from the TD to the TED. This might involve the allocation of deterministic uplink communication resources by means of a mechanism similar to, e.g., semi persistent scheduling so that the TDs can keep sending their input in a reliable and time deterministic manner. This might require that the TED accounts for T, e.g., by running a prediction model of the pose that allows predicting the actual current pose of the user giving past samples.

Similarly, the TED may require the communication system to allocate communication resources so that a TD in the environment can continuously receive the TD specific representation input that is generated in the TED. The TED might also need to account for the transmission delay in the local TE being T=Trendering+m+Tflight where Trendering is the time required for updating the rendering in the local TD once the data is received, m is the delay due to the discrete transmission time, and Tflight is the propagation time from the TED to the TD.

In this embodiment, the latency of the uplink communication, i.e., from TD to TED including the information about the TD (e.g., pose) as well as the latency of the downlink communication and local rendering might be part of the communication parameters considered when synchronizing the data streams from other users at other locations and/or applying the predictive models.

### System Architecture Enhancement for Next Generation Real Time Communication

TR 23.700-87 v1.0.0 describes the 5G system architecture enhancements for next generation real time communication including:
IMS network architecture enhancements required to support AR telephony communication for different types of AR-capable UEs.
IMS procedures including signalling and media processing need to be changed to support AR telephony communication

Solutions #8 and #9 in TR 23.700-87 address these architecture enhancements. In TR 23.700-87 is concluded that
the data channel architecture is used as baseline to support AR telephony communication.
If the UE needs network support for media rendering, the architecture and procedures specified in Solution #9 are used.
Otherwise, if the UE can perform the media rendering without network support, the procedures as specified in Solution #8 are taken as baseline for terminal rendering process.

In an embodiment, the system and functionalities described in Solution #8 in TR 23.700-87 are extended to support some embodiments described above. To this end, FIG. 6.8.2-1 in TR 23.700-87 and the related communication flow between two UEs including three procedures: (1) IMS multimedia telephony call; (2) bootstrap Data Channel (DC) establishment; and (3) application DC establishment may be further improved by means of embodiments in this application

The AR telephony communication is exchanged over RTP. In an embodiment, these procedures may be extended by:
Incorporating capabilities to determine the end-to-end latency between UEs, e.g., during application DC establishment or during application data exchange, and/or.
Incorporating capabilities to determine the end-to-end parameters, e.g., related positions or communication parameters between UEs, e.g., during application DC establishment or during application data exchange, and/or.
Incorporating the deployment of predictive models of a UE (or the UE environment), at the peer side, e.g., once the application DC establishment is finished, and/or
Incorporating capabilities to configure/synchronize of the communication flows (e.g. configure QoS) and/or compute resources (e.g. allocate CPU/storage resources at edge server) and/or policies (e.g. delays, sensor rates to apply) and/or compression algorithms.

In a further embodiment, the system and functionalities in Solution #9 in TR 23.700-87 are extended to support some embodiments described above. FIG. 6.9.2.2-1 in TR 23.700-87 describes a communication flow between two UEs with network rendering process in which the Augmented Reality (AR) media processing network function (ARMF), is responsible for AR communication media transmission and media rendering function, including the following functions:
AR Rendering Logic: controls the application-based rendering logic of AR communication.
AR Media Processing Function: including Vision Engine, 3D Rendering Engine. Vision Engine and 3D Rendering Engine will establish spatial map, and render the scenes, virtual human models and 3D object models according to the field of view, posture, position, etc. which are transmitted from UE using data channel.

In FIG. 6.9.2.2-1, the ARMF plays the role of the TE, TED or TSM as described in above embodiments. This solution/architecture/protocols in TR 23.700-87 can be extended to:
Incorporate capabilities to determine the end-to-end latency between UEs, e.g., during AR media rendering negotiation procedure, or during AR session media re-negotiation procedure for network rendering, or during the network rendering procedure, and/or.
Incorporate capabilities to determine the end-to-end parameters, e.g., related positions or communication parameters between UEs, e.g., during application DC establishment or during application data exchange, and/or.
Incorporate the capability of synchronizing incoming data streams of different remote users at different locations, in particular, regarding Step 20 (Send AR media over Application DC from UE-A to DCMF) and Step 21 (Transfer AR media to ARMF from DCMF to ARMF) or regarding Step 24 (Send rendered audio/video over RTP from UE-A to P-CSCF/IMS-AGW) and Step 25 (Transfer rendered audio/video to ARMF), and/or.
Incorporate the deployment of predictive models of a UE (or the UE environment), at the ARMF.
Incorporating capabilities to configure of/synchronize the communication flows (e.g. configure QoS) and/or compute resources (e.g. allocate CPU/storage resources at edge server) and/or policies (e.g. delays, sensor rates to apply) and/or compression algorithms.

In a further embodiment, a UE or the ARMF in charge of a UE UE1 synchronize the incoming data streams, e.g., DSi received from UE1 at UE1 with i=2, . . . , N. Synchronization is realized by determining delay Di of each DSi; determining the DSj that arrives with the highest delay Dj; delaying data stream DSi an amount Dj-Di where the delay can be performed by buffering DSi; and optionally passing all synchronized data streams to the corresponding predictive models PMi where all the PMi are configured to performed the prediction for the same latency. Each PMi takes as input (delayed) DSj and computes a predicted value. This embodiment represents a distributed approach in which each UE performs above synchronization (similarly, each UE is linked to an ARMF that performs such synchronization and/or prediction on behalf of the UE). This embodiment applies QoS equalization since all PM predict outputs based on the same delay Dj.

In a further embodiment, alternative to the previous one, the data stream DSi might not be synchronized with other DS and may be passed to PMi where PMi is configured to perform the prediction for latency Di (and not Dj). This embodiment applies QoS equalization. This embodiment does not apply QoS equalization since PMi predict output based on delay Di with i=1, . . . , N.

In a further embodiment, a centralized network entity, e.g., an application server (AS), e.g., a centralized ARMF or the ARMF in the home network or e.g. an AR Application Server as shown in FIG. 6.9.1.3-1 in TR 23.700-87, is in charge of such synchronization and/or prediction of the outputs on behalf of involved UEs. In this embodiment, it is relevant to consider that the (communication) parameters between UE1 and AS may be UE1 specific, e.g., the distance (and thus, minimum latency/delay Di) between UE1 and AS is UE1 specific. The AS might receive the data stream of UE1 (with i=1, . . . , N) with delay Di, the AS may synchronize them, e.g., as indicated in the previous embodiments. The AS may then apply the (optionally synchronized) received data streams to the predictive models PMi predicting outputs, e.g., Oi, further in the future at least a time Di so that when Oi is delivered at UE1, Oi is delivered on time based on the communication delay Di between the AS and UE1.

In a further embodiment, the UEs may perform synchronization and/or prediction of the outputs on behalf of involved UEs themselves, whereby the UEs may be configured by the ARMF or other network function or by an AR Application Server.

### Exemplary Use Cases

The above embodiments can support multiple use cases.

A first use case is about enabling real-time teleconference services.

In this first use case, three users are using the 5GS to join an immersive metaverse teleconference. The users Bob, Lukas, and Yong are located in the USA, Germany and China, respectively. Each of the users is served by a local metaverse edge computing server (MECS) hosted in the 5GS, each of the servers is located closed to the user it is serving. When a user joins the metaverse teleconference, the avatar of the user is loaded in the metaverse edge computing servers of the other users. For instance, the metaverse edge computing server close to Bob hosts the avatars of Yong and Lukas.

The huge distance between the users, e.g., the distance between USA and China is around 11640 Km, determines minimum communication latency, e.g., 11640/c=38 ms. This latency might also be variable due to multiple reasons, such as, e.g., congestion or delays introduced by (variable processing time of) hardware components such as sensors or rendering devices. Since this value maybe too high and variable for a truly immersive metaverse teleconference experience, each of the deployed avatars includes one or more predictive models of the person it represents and that allow rendering in the local edge server a synchronized predicted (current) avatar representation of the remote users.

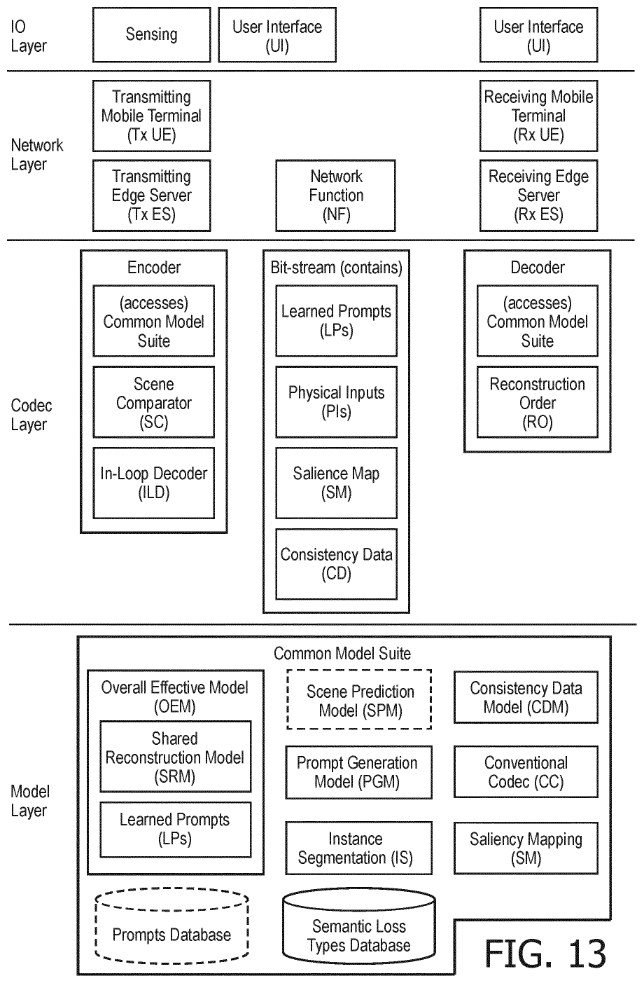

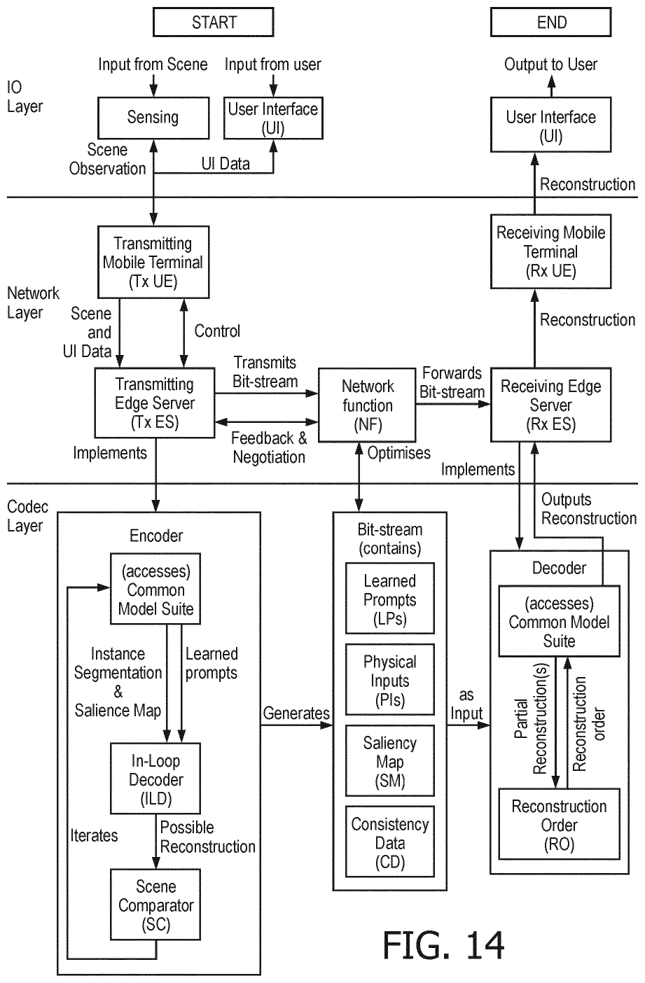

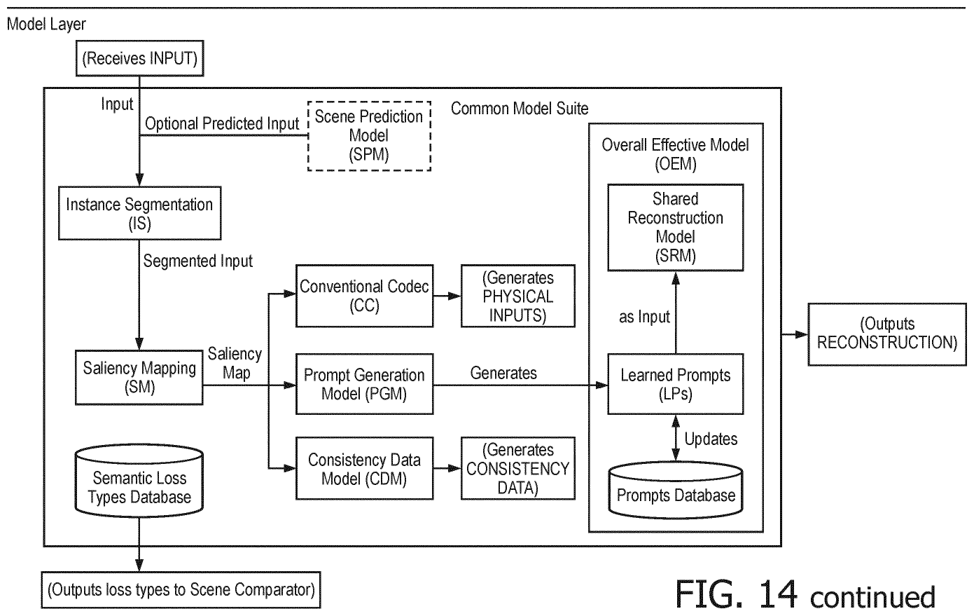

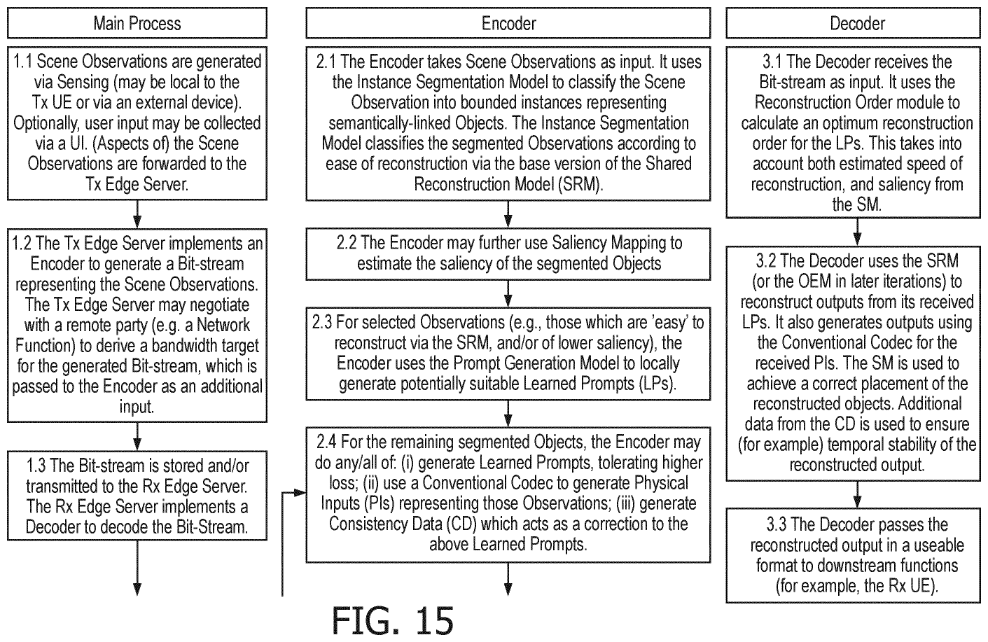

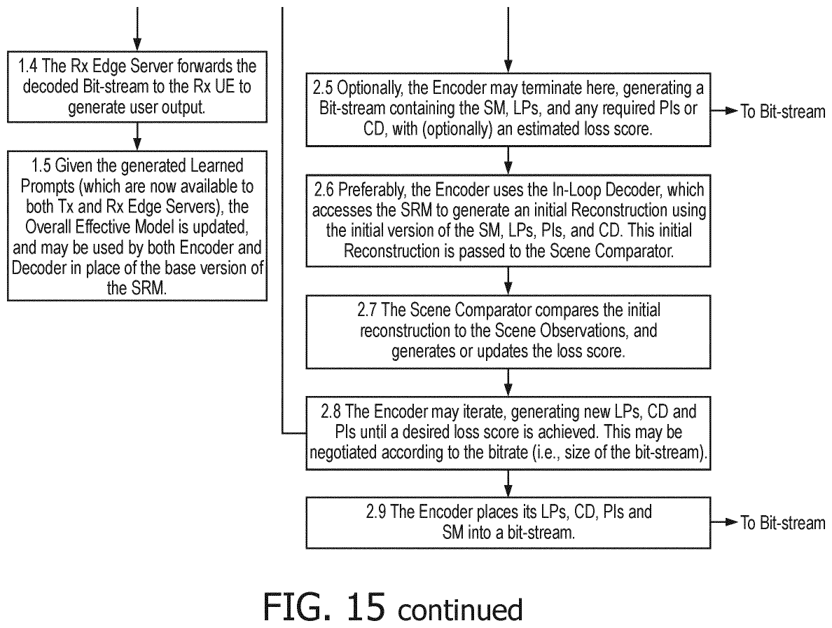

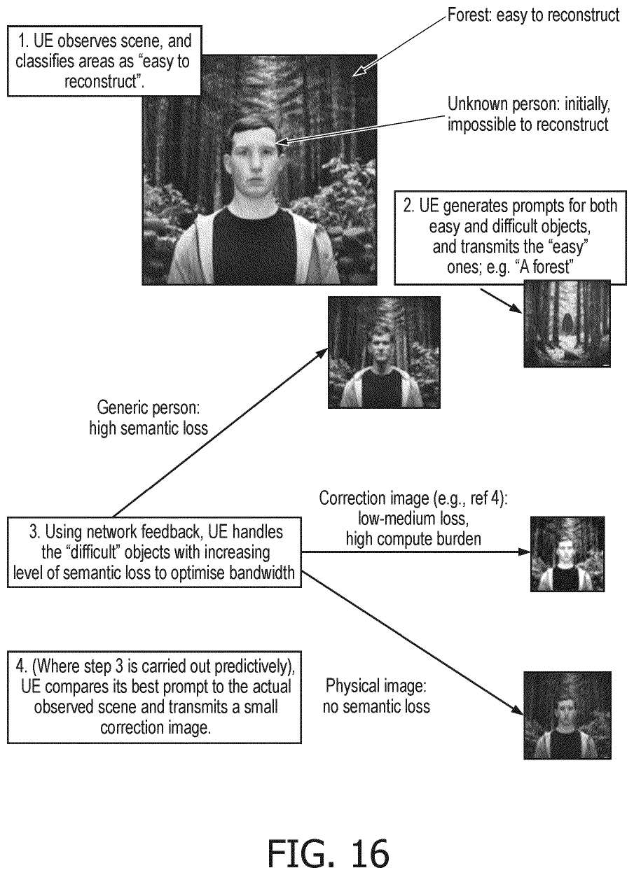

FIG. 12 shows this exemplary scenario in which a MECS at location 3 (USA) runs the predictive models of remote users (Yong and Lukas) and takes as input the received sensed data from all users (Yong, Lukas, and Bob) and generates a synchronized predicted (current) avatar representation of the users to be rendered in local rendering devices of Bob.

In this first use case, the following pre-conditions and assumptions apply to this use case:
1. Up to three different MNOs operate the 5GS providing metaverse teleconferencing services.
2. The users, Bob, Lukas, and Yong have subscribed to the metaverse teleconferencing services.
3. Each of the users, e.g., Bob, decide to join the teleconferencing session.

In this first use case, the following service flows need to be provided:
1. Each of the users, e.g., Bob, decide to join the teleconferencing session and give consent to the deployment of their avatars.
2. Metaverse sensors at each user sense a real-time recording of each of the users. The sensed real-time representation of each of the users is distributed to the metaverse edge computing servers of the other users in the metaverse teleconference session.
3. Each of the metaverse edge computing servers applies the incoming data stream representing each of the far located users to the corresponding avatar predictive models-taking into account the current communication parameters/performance, e.g., latency—to create a combined, synchronized, and current representation of the remote users that is provided as input to rendering devices in the local TE.

In this first use case, the main post-condition is that each of the users enjoy an immersive metaverse teleconference.

In this first use case, there is a new requirement needed to support the use case, namely, the 5G system shall provide means to synchronize the data streams of multiple metaverse (sensor and rendering) devices associated to different users locally at different locations. A second requirement refers to the need to supporting the distribution and execution of predictive model in edge server.

A second use case is about enabling real-time teleconference services.

In this second use case, three users are using the 5GS to join an immersive metaverse teleconference. The users Bob, Lukas, and Yong are located in the USA, Germany and China, respectively. Each of the users is served by a local metaverse edge computing server hosted in the 5GS, each of the servers located closed to the user it is serving. When the users join the metaverse teleconference, the avatar of each of the users is loaded in the metaverse edge computing servers of the other users. For instance, the metaverse edge computing server close to Bob hosts the avatars of Yong and Lukas.

The huge distance between the users, e.g., the distance between USA and China is around 11640 Km, determines minimum communication latency, e.g., 11640/c=38 ms. This latency might also be variable due to multiple reasons, such as, e.g., congestion or delays introduced by hardware components such as sensors or displays. Since this value is too high for a truly immersive metaverse teleconference experience, each of the deployed avatars includes one of more predictive models of the person it represents and that allow rendering in the edge server a predicted (current) representation of the person.

Each of the metaverse edge computing servers can combine the data streams coming from the other users and create a meaningful real-time representation of the users. Since the metaverse rendering devices of the users have limited rendering capabilities, a split rendering approach is applied, in which the metaverse edge computing servers perform the heavy rendering load and distribute to the metaverse rendering devices of the users a personalized view.

In this second use case, the following pre-conditions and assumptions apply to this use case:
1. Up to three different MNOs operate the 5GS providing metaverse teleconferencing services.
2. The users, Bob, Lukas, and Yong have subscribed to the metaverse teleconferencing services.
3. Each of the users, e.g., Bob, decide to join the teleconferencing session.

In this first use case, the following service flows need to be provided:
1. Each of the users, e.g., Bob, decide to join the teleconferencing session and give consent to the deployment of their avatars.
2. Metaverse sensors at each user sense a real-time recording of each of the users. The sensed real-time representation of each of the users is distributed to the metaverse edge computing servers of the other users in the metaverse teleconference session.
3. Each of the metaverse edge computing servers applies the real-time data stream representing each of the far located users to the corresponding avatar predictive models-taking into account the current communication parameters/performance, e.g., latency-rendering a combined, synchronized, and current representation of the remote users.
4. Each of the metaverse edge computing servers keeps gathering the current pose of the local user, e.g., position in his/her room, height, and orientation of his head, etc. by means of metaverse sensors around the user.
5. Each of the metaverse edge computing servers keeps processing:
(1) the rendered combined, synchronized, and current representation of the remote users while considering
(2) the current pose of the local user
to derive a view of the remote users for the local user that can be distributed to the metaverse rendering device of the local user.

In this second use case, the main post-condition is that each of the users enjoy an immersive metaverse teleconference.

In this second use case, there is also a new requirement needed to support the use case, namely, the 5G system shall provide means to synchronize the data streams of multiple metaverse (sensor and rendering) devices associated to different users locally at different locations. A second requirement refers to the need to supporting the distribution and execution of predictive model in edge server.

Thus, it can be defined a method and a corresponding edge server configured to execute such a method, where the method comprises
Receiving a predictive model at the edge server,
Receiving data from a remote User Equipment and/or Tactile Devices in a region of interest,
Rendering rendered data from the received data, for example by inferring missing samples,
Sending the rendered data to a destination User Equipment.

### GENERAL REMARKS

Although this invention was described in the context of virtual space such as Metaverse, its applications are not limited to such a type of operation. Low latency systems, e.g., in Industrial IoT systems, would also benefit from the teachings of this invention and its embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Additionally, the expression “at least one of A, B, and C” is to be understood as disjunctive, i.e. as “A and/or B and/or C”.

A single unit or device may fulfill the functions of several items recited in the claims. The mere fact that certain measures are recited in mutually different dependent claims does not indicate that a combination of these measures cannot be used to advantage.

The described operations like those indicated in the above embodiments may be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising
a processor circuit and a memory circuit, wherein the memory is arranged to store instructions for the processor circuit,
wherein the memory is arranged to store communication parameters,
wherein the communication parameters are shared between a third device and a first device and/or, between the third device and a second device,
wherein the processor circuit is arranged to receive a first communication flow from the first device,
wherein the processor circuit is arranged to receive a second communication flow from the second device,
wherein the first communication flow and the second communication flow are synchronized based on the communication parameters.

2. The apparatus of claim 1, wherein the communication parameters comprises:
the distance between the third device and the first device and/or the distance between the third device and the second device or
the latency from the first device to the third device and/or the latency from the second device to the third device or
other communication parameters shared between the first device and the third device and/or between the second device and the third device.

3. The apparatus of claim 1, further comprising a computational circuit,
wherein the computational circuit is executes a predictive model,
wherein the predictive model has an input the communication parameters between the first device and the third device,
wherein the predictive model is arranged to predict a control input for the third device,
wherein the control input comprises a predicted communication parameter between the device and the third device.

4. The apparatus of claim 1, further comprising a computational circuit,
wherein the computational circuit is executes a predictive model,
wherein the predictive model has an input the communication flow of at least the first device,
wherein the predictive model is arranged to predict a control input for the third device.

5. The apparatus in claim of claim 4, wherein the predictive model is selected from the group consisting of a model derived from a generic predictive model according to the parameters shared between the first device and the third device and a generative model.

6. The apparatus of claim 1, wherein the communication parameters are obtained from the first device.

7. The apparatus of claim 1, wherein the communication parameters are configured by a managing device.

8. The apparatus of claim 1, wherein the communication parameters are selected from the group consisting of a Latency between the third and the first device and/or second device, Quality of Service a Distance between the third device and the first device and/or the second device, a Computational requirement to process the communication, a Computational capabilities to process the communication, a Memory requirements to process the communication, a Memory capabilities to process the communication, an Available bitrate, a Number of communicating parties, a position relative to the third device and the first device and/or the second device, a speed relative to the third device and the first device and/or the second device, an acceleration relative to the third device and the first device and/or the second device, a rotation relative to the third device and the first device and/or the second device.

9. (canceled)

10. A method comprising:
storing communication parameters, wherein the communication parameters are shared between a third device and a first device, and/or, between the third device and a second device in memory;
receiving a first communication flow from the first device;
receiving a second communication flow from the second device; and,
synchronizing the communication flows based on the first communication flow and the second communication flow.

11. An apparatus comprising:
a storage circuit, wherein the storage circuit is arranged to store a prediction model of a first device;
a communication circuit, wherein the communication circuit is arranged to obtain a communication parameter, wherein the communication parameter is a characteristic of a communication link between the first device and the third devices; and
a computing circuit, wherein the computing circuit is arranged to use the prediction model,
wherein an output of the prediction model is based on the prediction model and the communication parameter.

12. The apparatus of claim 11, wherein the output of the prediction model arranges a synchronized communication flow between the first device and the third device.

13. The apparatus of claim 11,
wherein the output of the prediction model is a derived prediction model,
wherein the required number of input parameters in the derived prediction model is less than the required number of input parameters of the prediction model.

14. A method comprising:
storing a prediction model of a first device;
obtaining a communication parameter, wherein the communication parameter is a characteristic of a communication link between the first device and the third device; and
using the prediction model of the first device, wherein an output of the prediction model is based on the prediction model and the communication parameter.

15. A computer program stored on a non-transitory medium, wherein the computer program when executed on a processor performs the method as claimed in claim 10.

16. A computer program stored on a non-transitory medium, wherein the computer program when executed on a processor performs the method as claimed in claim 14.

17. An apparatus comprising
a processor circuit and a memory circuit, wherein the memory is arranged to store instructions for the processor circuit,
wherein the memory is arranged to store communication parameters,
wherein the communication parameters are shared between a third device and a first device and/or between the third device and a second device,
wherein the processor circuit is arranged to receive a first communication flow from the first device or a second communication flow from the second device,
wherein the first communication flow and the second communication flow are synchronized based on the communication parameters.

18. A method comprising:
storing communication parameters, wherein the communication parameters are shared between a third device and a first device, and/or, between the third device and a second device in memory;
receiving a first communication flow from the first device or a second communication flow from the second device; and
synchronizing the communication flows based on the first communication flow and the second communication flow.

19. The method of claim 10, wherein the communication parameters comprises:
the distance between the third device and the first device and/or the distance between the third device and the second device or
the latency from the first device to the third device and/or the latency from the second device to the third device or
other communication parameters shared between the first device and the third device and/or between the second device and the third device.

20. The method of claim 10, further comprising executing a predictive model,
wherein the predictive model has an input the communication parameters between the first device and the third device,
wherein the predictive model is arranged to predict a control input for the third device,
wherein the control input comprises a predicted communication parameter between the device and the third device.

21. The method of claim 10, further comprising executing a predictive model,
wherein the predictive model has an input the communication flow of at least the first device,
wherein the predictive model is arranged to predict a control input for the third device.

22. The method of claim 21, wherein the predictive model is selected from the group consisting of a model derived from a generic predictive model according to the parameters shared between the first device and the third device and a generative model.

23. The method of claim 10, wherein the communication parameters are obtained from the first device.

24. The method of claim 10, wherein the communication parameters are configured by a managing device.
